(19) United States
(12) Patent Application Publication
(10) Pub. No.: US 2016/0083540 A1
(43) Pub. Date: Mar. 24, 2016

(54) ARTICLES MADE FROM THERMOPLASTIC POLYURETHANES WITH CRYSTALLINE CHAIN ENDS

(71) Applicant: LUBRIZOL ADVANCED MATERIALS, INC., Cleveland, OH (US)

(72) Inventors: Umit G. Makal, Stow, OH (US); Bryce W. Steinmetz, Medina, OH (US); Qiwei Lu, Seven Hills, OH (US); Roger W. Day, Solon, OH (US)

(21) Appl. No.: 14/890,171

(22) PCT Filed: May 21, 2014
(86) PCT No.: PCT/US2014/038879

§ 371 Date: Nov. 10, 2015

Related U.S. Application Data
(60) Provisional application No. 61/826,096, filed on May 22, 2013.

(51) Int. Cl. C08J 5/18; D01F 6/70

(52) U.S. Cl. CPC C08J 5/18; D01F 6/70; C08J 2375/08; C08J 2423/06

(57) ABSTRACT

The present invention relates to articles made from thermoplastic polyurethane (TPU) compositions that have crystalline chain ends. The TPU compositions used to make the articles of the invention can provide reduced stickiness and/or tackiness, while maintaining other desirable physical properties, leading to significantly improved handling and processability.

### FIELD OF THE INVENTION

The present invention relates to articles made from thermoplastic polyurethane (TPU) compositions that have crystalline chain ends. The TPU compositions used to make the articles of the invention can provide reduced stickiness and/or tackiness, while maintaining other desirable physical properties, leading to significantly improved handling and processability.

### BACKGROUND OF THE INVENTION

Thermoplastic polyurethane (TPU) compositions are highly useful materials that can provide an attractive combination of physical properties. TPUs may be generally described as segmented copolymers, having one or more low glass transition temperature (Tg) soft segments and one or more high Tg hard segments.

There is a continuing need to provide improved TPU compositions that provide improved physical properties, that are easier to process, that are easier to scale to commercial quantities, that can be made via a continuous process, that are more versatile in how they can be used with other materials, or some combination thereof.

There is an ongoing need for TPU compositions that can be more easily processed, and which have improved processing windows, and more specifically, can be scaled to continuous commercial quantity processes. Many TPU compositions have very narrow processing windows, a very tight set of conditions under which they process well. Small changes in processing conditions, which cannot always be easily controlled, can lead to significant variations in product quality. Thus, there are many TPU compositions that could be made in the lab and which could have interesting combinations of properties, but which effectively cannot be commercialized because they cannot be produced in commercially effective processes.

Thus, there is a need for TPU compositions that can be more easily processed, and which have improved processing windows, which are not as sensitive to changes in processing conditions, including developing TPU compositions with desired combinations of properties that can be produced in commercially effective processes, for example continuous reactive extruders.

Thus, there is a need for the various TPU compositions described above and the useful articles that can be made from such TPU compositions.

Various embodiments of the invention described herein address one or more of the needs described above.

### SUMMARY OF THE INVENTION

The present invention provides various articles made from a thermoplastic polyurethane (TPU) composition includes the reaction product of (i) a polyisocyanate component, (ii) at least one of a chain extender component and a polyol component, and (iii) a chain terminator component. The chain terminator component comprises a short chain crystalline compound containing more than 12 carbon atoms and a single NCO-reactive functional group capable of terminating the chain of a TPU resulting from the reaction of components (i) and (ii).

The functional group of the short chain crystalline compound may in some embodiments be described as an active-hydrogen functional group located at a terminal position within the crystalline compound.

The invention further provides articles made from TPU compositions where the functional group of the short chain crystalline compound is a hydroxyl (alcohol) functional group, a primary amine functional group, a secondary amine functional group, an anhydride functional group, an epoxy functional group, a thiol functional group, a carboxy (carboxylic acid) functional group, an isocyanate functional group, or a combination thereof. The short chain crystalline compound may be a polyolefin that contains from 20 to 70 carbon atoms. The short chain crystalline compound may include one or more alpha-hydroxy terminated polyalphaolefins or ethoxylated versions thereof. The polyalphaolefin may include a polyethylene, a polypropylene, a poly(ethylene-co-alphaolefin) copolymer, a poly(propylene-co-alphaolefin) copolymer, or any combination thereof.

The invention further provides articles made from TPU compositions where the TPU is represented by the following structure:

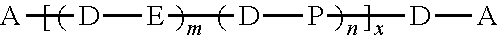

wherein each A is an end group derived from the mono-functional short chain crystalline compound; each D is a group derived from the polyisocyanate component; each E is derived from the chain extender component; each P is derived from the polyol component; each m is an integer from 0 to 15; each n is an integer from 0 to 20; and x is an integer from 1 to 50; with the proviso that at least one of m and n is greater than 0.

The invention further includes articles made from any of the TPU compositions described above where: the polyisocyanate component comprises a diisocyanate; where the chain extender component, when present, comprises a diol, a diamine, or a combination thereof; and where the polyol component, when present, comprises a polyether polyol, a polyester polyol, a polycarbonate polyol, a polysiloxane polyol, or a combination thereof. In some embodiments, the polyisocyanate component includes MDI, H12MDI, HDI, TDI, IPDI, LDI, BDI, PDI, CHDI, TODI, NDI or a combination thereof; the chain extender component, when present, comprises ethylene glycol, butanediol, hexamethylenediol, pentanediol, heptanediol, nonanediol, dodecanediol, ethylenediamine, butanediamine, hexamethylenediamine, or a combination thereof; and the polyol component, when present, comprises a poly(ethylene glycol), poly(tetramethylene glycol), poly(trimethylene oxide), ethylene oxide capped polypropylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, poly(dimethyl siloxane) polyol, or any combination thereof.

The invention further provides a process of making articles made from the TPU compositions, including the steps of: (I) reacting (i) a polyisocyanate component, (ii) at least one of a chain extender component and a polyol component, and (iii) the described chain terminator component; resulting in a TPU with crystalline end groups, and (II) forming the described article from the TPU.

The invention also provides certain embodiments of the invention where the articles are made from ultra-soft TPU compositions, which in some embodiments may be defined as having a Shore hardness of below 65 A, even in some embodiments without the use of a plasticizer. In some of these embodiments, the polyisocyanate component comprises a diisocyanate; the chain extender component, when present, comprises a diol; and the polyol component, when present, comprises a polyether polyol, a polyester polyol, or a combination thereof.

The invention further provides certain embodiments of the invention where the articles are made from TPU compositions where the mono-functional short chain crystalline end group of the resulting TPU is then also grafted with a vinyl alkoxysilane moiety in the presence of a peroxide.

The invention also includes articles made from vinyl alkoxysilane grafted TPU compositions where the TPU is crosslinked by formation of siloxane crosslinks upon hydrolysis and subsequent condensation of the alkoxysilane groups. This results in a crosslinked network of the TPU.

The invention also includes a process of making such articles made from such TPU compositions where the process includes the steps of: (I) reacting (i) a polyisocyanate component, (ii) at least one of a chain extender component and a polyol component, and (iii) a chain terminator component. The chain terminator component may include a short chain crystalline compound containing more than 12 carbon atoms and a single NCO-reactive functional group capable of terminating the chain of a thermoplastic polyurethane resulting from the reaction of components (i) and (ii). This reaction results in a TPU with crystalline end groups, where the resulting TPU with crystalline end groups is further reacted with a crosslinkable vinyl alkoxysilane moiety in the presence of a peroxide, resulting in a TPU with crystalline end groups where the crystalline end groups contain a crosslinkable vinyl alkoxysilane group, and (II) forming the article.

The invention further includes the process where such TPU compositions are crosslinked by formation of siloxane crosslinks upon hydrolysis and subsequent condensation of the alkoxysilane groups, resulting in a crosslinked network of the TPU.

The invention also provides a method of making articles from a TPU composition crosslinkable by UV, E-beam or gamma-beam irradiation. This method includes the step of: (I) adding the described chain terminator component, and optionally a photoinitiator, to a TPU reaction mixture, resulting in a TPU that is crosslinkable by UV (when the photoinitiator is present), E-Beam or gamma-beam irradiation, and (II) forming said article. The described method may also include the additional the step of: (III) crosslinking the resulting thermoplastic polyurethane by UV (when the photoinitiator is present), E-Beam or gamma-beam irradiation; resulting in a crosslinked thermoplastic polyurethane network.

The invention further provides any of the article described above where the article is prepared by calendering, casting, coating, compounding, extrusion, foaming, laminating, blow molding, compression molding, injection molding, thermoforming, transfer molding, cast molding, rotational molding, casting such as for films, spun or melt bonded such as for fibers, or any combination thereof.

The invention further provides for an article where the thermoplastic polyurethane composition is included in a film. That is the invention provides for a film, as well as other articles that include such a film, where the film includes (i.e., is made from) the thermoplastic polyurethane composition described herein.

In some embodiments, the film includes a monolayer film, a multilayer film, a breathable film, or any combination thereof.

In some embodiments, the film is formed by extrusion, co-extrusion, extrusion coating, lamination, blowing and then casting, or any combination thereof.

The invention further provides for an article where the thermoplastic polyurethane composition is included in a molded product, or a molded article. That is the invention provides for a molded product and/or a molded article, as well as other articles that include such molded products and/or molded articles, where the molded product and/or molded article includes (i.e., is made from) the thermoplastic polyurethane composition described herein.

In some embodiments, the molded product includes a molded part, an over-molded part, a molded laminate thermoplastic polyurethane composition, a molded foamed thermoplastic polyurethane composition, or any combination thereof.

In some embodiments, the molded product is formed by injection molding, gas-assisted injection molding, blow molding, extrusion blow molding, injection blow molding, injection stretch blow molding, compression molding, rotational molding, foam molding, thermoforming, sheet extrusion, profile extrusion, vacuum forming, slush molding, transfer molding, wet lay-up or contact molding, cast molding, cold forming matched-die molding, spray techniques, profile co-extrusion, or any combination thereof.

The invention further provides for an article where the thermoplastic polyurethane composition is included in fiber. That is, the invention provides for a fiber, as well as other articles that include such a fiber, where the fiber includes (i.e., is made from) the thermoplastic polyurethane composition described herein.

In some embodiments, the fiber includes a monofilament fiber or multifilament fiber.

In some embodiments, the fiber is formed by melt blowing, spunbonding, film aperturing, staple fiber carding, continuous filament spinning, or bulked continuous filament spinning.

The invention further provides for an article where the thermoplastic polyurethane composition is included in fabric, and/or where the thermoplastic polyurethane composition is included in fiber and the fiber is then made into a fabric. That is, the invention provides for a fabric, as well as other articles that include such a fabric, where the fabric includes (i.e., is made from) the thermoplastic polyurethane composition described herein, which in at least some embodiments means the fabric includes fibers where the fibers include (i.e., are made from) the thermoplastic polyurethane composition described herein.

In some embodiments, the fabric further includes one or more additional fibers made from materials other than the thermoplastic polyurethane composition.

In some embodiments, the fabric includes a non-woven fabric, a knitted fabric, or a woven fabric.

The invention further provides for an article where the thermoplastic polyurethane composition is included in garment, and/or where the thermoplastic polyurethane composition is included in a fabric and the fabric is then made into a garment. That is, the invention provides for a garment, as well as other articles that include such a garment, where the garment includes (i.e., is made from) the thermoplastic polyurethane composition described herein, which in at least some embodiments means the garment includes fabrics where the fabrics include (i.e., are made from) the thermoplastic polyurethane composition described herein, which in at least some embodiments means the fabric includes fibers where the fibers include (i.e., are made from) the thermoplastic polyurethane composition described herein.

In some embodiments, the garment includes sports apparel, shirts, tights, bodysuits, gloves (made from the fabric), workwear, intimates, medical garments, bedding articles, or any combination thereof.

The invention further provides for an article where the thermoplastic polyurethane composition is included in a footwear article. That is the invention provides for a footwear article that includes (i.e., is made from) the thermoplastic polyurethane composition described herein. The thermoplastic polyurethane composition may be used to make one or more components of the footwear article.

In some embodiments, the thermoplastic polyurethane composition is present in the footwear article as a film. In some embodiments, the thermoplastic polyurethane composition is present in the footwear article as a molded product. In some embodiments, the thermoplastic polyurethane composition is present in the footwear article as a fiber. In some embodiments, the thermoplastic polyurethane composition is present in the footwear article as a fabric.

In some embodiments, the footwear article includes a shoe outsole, a shoe midsole, a shoe unitsole, an overmolded article, a natural leather article, a synthetic leather article, an upper, a laminated article, a coated article, a boot, a sandal, galoshes, a plastic shoe, or any combinations thereof.

In some embodiments, the invention provides for molded articles, fibers, and/or woven fabrics made some such fibers, made from the described TPU compositions and/or blends thereof.

The invention further provides for an article where the thermoplastic polyurethane composition is included in an extruded part. That is, the invention provides for an extruded part, as well as other articles that include such an extruded part, where the extruded part includes (i.e., is made from) the thermoplastic polyurethane composition described herein.

In some embodiments, the extruded article comprises a sheet, a film, a tube, a hose, a jacket of a wire and cable construction, a combination of one or more thereof, or a liner of one or more thereof.

### DETAILED DESCRIPTION OF THE INVENTION

Various preferred features and embodiments will be described below by way of non-limiting illustration.

The TPU compositions used to make the articles of the present invention include the reaction product of (i) a polyisocyanate component, (ii) at least one of a chain extender component and a polyol component, and (iii) a chain terminator component. The chain terminator component includes a short chain crystalline compound containing more than 12 carbon atoms and a single NCO-reactive functional group capable of terminating the chain of a thermoplastic polyurethane resulting from the reaction of components (i) and (ii).

In some embodiments, the TPU includes reaction product of (i) the polyisocyanate component, (ii) the chain extender component, and (iii) the chain terminator component. In such embodiments, the reaction may be essentially free of or even completely free of any polyol component.

In some embodiments, the TPU includes the reaction product of (i) the polyisocyanate component, (ii) the polyol component, and (iii) the chain terminator component. In such embodiments, the reaction may be essentially free of or even completely free of any chain extender component.

In some embodiments, the TPU includes reaction product of (i) the polyisocyanate component, (ii) the chain extender component and the polyol component, and (iii) the chain terminator component.

In any of these embodiments, the molar ratio of the NCO groups provided by the compounds making up component (i) and the NCO reactive groups provided by the compounds making up components (ii) and (iii), for example, —OH groups, may be from 0.92 to 1.08, or from 0.96 to 1.04, or from 0.98 to 1.02, or from 0.99 or 1.01, or even about 1. That is, the molar ratio of NCO groups over NCO reactive groups present in the reaction mixture used to prepare the described TPU may from 0.92 to 1.08, or from 0.96 to 1.04, or from 0.98 to 1.02, or from 0.99 or 1.01, or even about 1.

In some embodiments, the TPU is represented by the following structure:

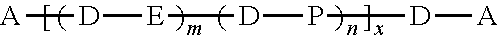

wherein each A is an end group derived from the mono-functional short chain crystalline compound; each D is a group derived from the polyisocyanate component; each E is derived from the chain extender component; each P is derived from the polyol component; each m is an integer from 0 to 15; each n is an integer from 0 to 20; and x is an integer from 1 to 50; with the proviso that at least one of m and n is greater than 0.

In some embodiments, m in the structure above is from 0 to 15, or 0 to 10, or 0 to 5, or 1 to 15, or 5 to 15, or even 5 to 10. In some embodiments, n in the structure above is from 0 to 20, or 0 to 15, or 0 to 10, or 0 to 5, or 1 to 20, or 5 to 20, or 5 to 15, or 5 to 10, or 10 to 20, or even 10 to 15. In some embodiments, x in the structure above is from 1 to 50, or 10 to 50, or 20 to 50, or 20 to 40, or even 25 to 35.

### The Polyisocyanate Component

The TPU compositions of the invention are made using (i) a polyisocyanate component, which includes one or more polyisocyanates. In some embodiments, the polyisocyanate component includes one or more diisocyanates.

Suitable polyisocyanates include aromatic diisocyanates, aliphatic diisocyanates, or combinations thereof. In some embodiments, the polyisocyanate component of the invention includes one or more aromatic diisocyanates. In some embodiments, the polyisocyanate component of the invention is essentially free of, or even completely free of, aliphatic diisocyanates.

Examples of useful polyisocyanates include aromatic diisocyanates such as 4,4′-methylenebis(phenyl isocyanate) (MDI), m-xylene diisocyanate (XDI), phenylene-1,4-diisocyanate, naphthalene-1,5-diisocyanate, and toluene diisocyanate (TDI); as well as aliphatic diisocyanates such as isophorone diisocyanate (IPDI), 1,4-cyclohexyl diisocyanate (CHDI), decane-1,10-diisocyanate, lysine diisocyanate (LDI), 1,4-butane diisocyanate (BDI), isophorone diisocyanate (PDI), 3,3′-Dimethyl-4,4′-biphenylene diisocyanate (TODI), 1,5-naphthalene diisocyanate (NDI), and dicyclohexylmethane-4,4′-diisocyanate (H12MDI). Mixtures of two or more polyisocyanates may be used. In some embodiments, the polyisocyanate is MDI and/or H12MDI. In some embodiments, the polyisocyanate includes MDI. In some embodiments, the polyisocyanate may include H12MDI. In some embodiments, the polyisocyanate component of the invention is essentially free of, or even completely free of, hexamethylene diisocyanate (HDI).

### The Chain Extender Component

The TPU compositions of the invention are made using (ii) at least one of a chain extender component and a polyol component. In some embodiments, a chain extender component is present. Chain extenders include diols, diamines, and combinations thereof.

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy)phenyl]propane (HEPP), hexamethylenediol, heptanediol, nonanediol, dodecanediol, ethylenediamine, butanediamine, hexamethylenediamine, and hydroxyethyl resorcinol (HER), and the like, as well as mixtures thereof. In some embodiments, the chain extender includes BDO, HDO, or a combination thereof. In some embodiments, the chain extender includes BDO. Other glycols, such as aromatic glycols could be used, but in some embodiments the TPUs of the invention are essentially free of or even completely free of such materials.

In some embodiments, the chain extender used to prepare the TPU is substantially free of, or even completely free of, 1,6-hexanediol. In some embodiments, the chain extender used to prepare the TPU includes a cyclic chain extender. Suitable examples include CHDM, HEPP, HER, and combinations thereof. In some embodiments, the chain extender used to prepare the TPU includes an aromatic cyclic chain extender, for example, HEPP, HER, or a combination thereof. In some embodiments, the chain extender used to prepare the TPU includes an aliphatic cyclic chain extender, for example CHDM. In some embodiments, the chain extender used to prepare the TPU is substantially free of, or even completely free of aromatic chain extenders, for example, aromatic cyclic chain extenders. In some embodiments, the chain extender used to prepare the TPU is substantially free of, or even completely free of polysiloxanes.

In some embodiments, the chain extender component, when present, includes ethylene glycol, butanediol, hexamethylenediol, pentanediol, heptanediol, nonanediol, dodecanediol, ethylenediamine, butanediamine, hexamethylenediamine, or a combination thereof.

### The Polyol Component

The TPU compositions of the invention are made using (ii) at least one of a chain extender component and a polyol component. In some embodiments, the polyol component is present. Polyols include polyether polyols, polyester polyols, polycarbonate polyols, polysiloxane polyols, and combinations thereof.

Suitable polyols, which may also be described as hydroxyl terminated intermediates, when present, may include one or more hydroxyl terminated polyesters, one or more hydroxyl terminated polyethers, one or more hydroxyl terminated polycarbonates, one or more hydroxyl terminated polysiloxanes, or mixtures thereof.

Suitable hydroxyl terminated polyester intermediates include linear polyesters having a number average molecular weight (Mn) of from about 500 to about 10,000, from about 700 to about 5,000, or from about 700 to about 4,000, and generally have an acid number generally less than 1.3 or less than 0.5. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycol described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

Suitable hydroxyl terminated polyether intermediates include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, polypropylene glycol) comprising propylene oxide reacted with propylene glycol, poly(tetramethylene glycol) comprising water reacted with tetrahydrofuran (PTMEG). In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of THF and ethylene oxide or THF and propylene oxide. These are available from BASF as Poly THF B, a block copolymer, and poly THF R, a random copolymer. The various polyether intermediates generally have a number average molecular weight (Mn) as determined by assay of the terminal functional groups which is an average molecular weight greater than about 700, such as from about 700 to about 10,000, from about 1000 to about 5000, or from about 1000 to about 2500. In some embodiments the polyether intermediate includes a blend of two or more different molecular weight polyethers, such as a blend of 2000 Mₙ and 1000 Mₙ PTMEG.

Suitable hydroxyl terminated polycarbonates include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecular with each alkoxy group containing 2 to 4 carbon atoms. Diols suitable for use in the present invention include aliphatic diols containing 4 to 12 carbon atoms such as 1,4-butanediol, 1,5-pentanediol, neopentyl glycol, 1,6-hexanediol, 1,6-2,2,4-trimethylhexanediol, 1,10-decanediol, hydrogenated dilinoleylglycol, hydrogenated dioleylglycol; and cycloaliphatic diols such as 1,3-cyclohexanediol, 1,4-dimethylolcyclohexane-, 1,4-cyclohexanediol, 1,3-dimethylolcyclohexane, 1,4-endo methylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Suitable polysiloxane polyols include alpha-omega-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5000, or from 400 to 3000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone.

In some embodiments, the polysiloxanes may be represented by one or more compounds having the following formula:

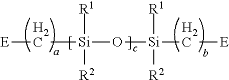

in which: each R¹ and R² are independently a 1 to 4 carbon atom alkyl group, a benzyl, or a phenyl group; each E is OH or NHR³ where R³ is hydrogen, a 1 to 6 carbon atom alkyl group, or a 5 to 8 carbon atom cyclo-alkyl group; a and b are each independently an integer from 2 to 8; c is an integer from 3 to 50. In amino-containing polysiloxanes, at least one of the E groups is NHR₃. In the hydroxyl-containing polysiloxanes, at least one of the E groups is OH. In some embodiments, both R¹ and R² are methyl groups.

Suitable examples include alpha-omega-hydroxypropyl terminated poly(dimethysiloxane) and alpha-omega-amino propyl terminated poly(dimethysiloxane), both of which are commercially available materials. Further examples include copolymers of the poly(dimethysiloxane) materials with a poly(alkylene oxide).

The polyol component, when present, may include poly(ethylene glycol), poly(tetramethylene glycol), poly(trimethylene oxide), ethylene oxide capped polypropylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, or any combination thereof.

Examples of dimer fatty acids that may be used to prepare suitable polyester polyols include Priplast™ polyester gylcols/polyols commercially available from Croda and Radia® polyester glycols commercially available from Oleon.

In some embodiments, the polyol component includes a polyether polyol. In some embodiments the polyol component is essentially free of or even completely free of polyester polyols. In some embodiments, the polyol component used to prepare the TPU is substantially free of, or even completely free of polysiloxanes.

### The Chain Terminator Component

The TPU compositions of the invention are made using (iii) a chain terminator component. The chain terminator component includes a short chain crystalline compound containing more than 12 carbon atoms and a single NCO-reactive functional group capable of terminating the chain of a TPU resulting from the reaction of components (i) and (ii).

In some embodiments, the short chain crystalline compound is a short chain crystalline polyolefin. By “short chain” it is meant that the crystalline compound contains less than 200 carbon atoms, or even less than 100, 75, 70, 63, 60 or even 50 carbon atoms, but always more than 12 carbon atoms. In some embodiments, the short chain crystalline compounds contain from 13 to 70, 20 to 70, 23 to 63, or even from 24 to 50 carbon atoms. Generally speaking, the short chain crystalline compounds are linear.

The single functional group of the short chain crystalline compound may be an NCO-reactive functional group located at a terminal position within the crystalline compound. In other embodiments the single functional group may be described as an active-hydrogen functional group, again located at a terminal position within the crystalline compound. Suitable functional groups include a hydroxyl (alcohol) functional group, a primary amine functional group, a secondary amine functional group, an anhydride functional group, an epoxy functional group, a thiol functional group, a carboxy (carboxylic acid) functional group, a isocyanate functional group, or a combination thereof.

In some embodiments, the short chain crystalline compound is a compound with an amine functional group, a carboxylic acid functional group, or a hydroxyl (alcohol) functional group. In some embodiments, the short chain crystalline compound is a hydroxyl (alcohol) functional group. In some embodiments, isocyanate functional groups are excluded from the invention that is the short chain crystalline compound may be essentially free of or even completely free of isocyanate functional groups, including diisocyanate functional groups.

In some embodiments, the short chain crystalline compound comprises one or more alpha-hydroxy terminated polyalphaolefins or ethoxylated versions thereof. Useful polyalphaolefins include polyethylene, polypropylene, poly(ethylene-co-alphaolefin) copolymer, poly(propylene-co-alphaolefin) copolymer, or any combination thereof.

It is important that the short chain crystalline compound have a single functional group, as the mono-functional nature of the compound is required in order to control the stoichiometry of the TPU forming reaction. If the short chain crystalline compound is not mono-functional (if it contains more than one functional group), it will not act as a chain terminator, but rather as an additional chain extender. It is understood that some amount of multi-functional material may be present in the short chain crystalline compound, however, the present invention contemplates the chain terminator component being at least mostly mono-functional short chain crystalline compounds, and in some embodiments at least 70, 80, 90, or even 99.5 percent by weight mono-functional short chain crystalline compounds. In still other embodiments, the chain terminator component is essentially free of or even completely free of multi-functional compounds.

In some embodiments, the chain terminator component is essentially free of, or even completely free of crystalline hydrocarbon waxes.

In some embodiments, the chain terminator component includes polyethylene mono alcohols, ethoxylated polyethylene mono alcohols, carboxylic acid terminated polyethylene, or any combination thereof.

Commercial examples of such mono-functional short chain crystalline compounds useful in the present invention include UNILIN™ alcohols, UNITHOX™ alcohols, and UNICID™ acids, all of which are commercially available from Baker Hughes. UNILIN™ 350 is a C33 crystalline mono-ol chain terminator. UNILIN™ 700 is a C63 crystalline mono-ol chain terminator.

In some embodiments of the invention, the polyisocyanate component includes a diisocyanate; the chain extender component, when present, includes a diol, a diamine, or a combination thereof and the polyol component, when present, includes a polyether polyol, a polyester polyol, a polycarbonate polyol, or a combination thereof.

In some embodiments, of the invention the polyisocyanate component comprises MDI, H12MDI, HDI, TDI, IPDI, LDI, BDI, PDI, TODI, NDI or a combination thereof the chain extender component, when present, comprises ethylene glycol, butanediol, hexamethylenediol, pentanediol, heptanediol, nonanediol, dodecanediol, ethylenediamine, butanediamine, hexamethylenediamine, or a combination thereof; and the polyol component, when present, comprises a poly(ethylene glycol), poly(tetramethylene glycol), poly(trimethylene oxide), ethylene oxide capped poly(propylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, or any combination thereof.

In still further embodiments, the compositions of the invention may further include one or more polyolefins. That is, the compositions of the invention may also include blends of one or more of the described TPU's with one or more additional polymers, for example one or more polyolefins. Such additional components, for example, such additional polyolefins, are not overly limited. In some embodiments, these blends are essentially free of or even completely free of thermoplastics other than the TPU of the invention.

The TPU of the invention may be prepared by a process that includes the steps of: (I) reacting (i) the polyisocyanate component, (ii) at least one of the chain extender component and the polyol component, and (iii) the chain terminator component. The resulting TPU has crystalline end groups where the short chain crystalline compound of the chain terminator component forms the end groups of the TPU chains. Any of the TPU materials described herein may be made by this process.

The described process for preparing the TPU of the invention includes both the “pre-polymer” process and the “one shot” process, in either a batch or continuous manner. That is, in some embodiments, the TPU may be made by reacting the components together in a “one shot” polymerization process wherein all of the components, including reactants are added together simultaneously or substantially simultaneously to a heated extruder and reacted to form the TPU. While in other embodiments, the TPU may be made by first reacting the polyisocyanate component with some portion of the polyol component forming a pre-polymer, and then completing the reaction by reacting the pre-polymer with the remaining reactants, resulting in the TPU.

In some embodiments, the components used in the preparation of the TPU are essentially free of or even completely free of maleated materials, including for example maleated polyolefins. In some embodiments, the components used in the preparation of the TPU are essentially free of or even completely free of thermoplastics, except for the TPU materials of the invention. In some embodiments, the TPU of the invention is made via a prepolymer process where a single prepolymer composition is used. In some embodiments, the TPU of the invention is made via continuous process.

### Additional Components

The TPU compositions of the invention may also include one or more additional components.

In some embodiments, the additional component is a flame retardant. Suitable flame retardants are not overly limited and may include a boron phosphate flame retardant, a magnesium oxide, a dipentaerythritol, a polytetrafluoroethylene (PTFE) polymer, or any combination thereof. In some embodiments, this flame retardant may include a boron phosphate flame retardant, a magnesium oxide, a dipentaerythritol, or any combination thereof. A suitable example of a boron phosphate flame retardant is BUDIT 326, commercially available from Budenheim USA, Inc. When present, the flame retardant component may be present in an amount from 0 to 10 weight percent of the overall TPU composition, in other embodiments from 0.5 to 10, or from 1 to 10, or from 0.5 or 1 to 5, or from 0.5 to 3, or even from 1 to 3 weight percent of the overall TPU composition.

The TPU compositions of the invention may also include additional additives, which may be referred to as a stabilizer. The stabilizers may include antioxidants such as phenolics, phosphites, thioesters, and amines, light stabilizers such as hindered amine light stabilizers and benzothiazole UV absorbers, and other process stabilizers and combinations thereof. In one embodiment the preferred stabilizer is Irganox 1010 from BASF and Naugard 445 from Chemtura. The stabilizer is used in the amount from about 0.1 weight percent to about 5 weight percent, in another embodiment from about 0.1 weight percent to about 3 weight percent, and in another embodiment from about 0.5 weight percent to about 1.5 weight percent of the TPU composition.

In addition, various conventional inorganic flame retardant components may be employed in the TPU composition. Suitable inorganic flame retardants include any of those known to one skilled in the art, such as metal oxides, metal oxide hydrates, metal carbonates, ammonium phosphate, ammonium polyphosphate, calcium carbonate, antimony oxide, clay, mineral clays including talc, kaolin, wollastonite, nanoclay, montmorillonite clay which is often referred to as nano-clay, and mixture thereof. In one embodiment, the flame retardant package includes talc. The talc in the flame retardant package promotes properties of high limiting oxygen index (LOI). The inorganic flame retardants may be used in the amount from 0 to about 30 weight percent, from about 0.1 weight percent to about 20 weight percent, in another embodiment about 0.5 weight percent to about 15 weight percent of the total weight of the TPU composition.

Still further optional additives may be used in the TPU compositions of the invention as well. The additives include colorants, antioxidants (including phenolics, phosphites, thioesters, and/or amines), antiozonants, stabilizers, inert fillers, lubricants, inhibitors, hydrolysis stabilizers, light stabilizers, hindered amines light stabilizers, benzotriazole UV absorber, heat stabilizers, stabilizers to prevent discoloration, dyes, pigments, inorganic and organic fillers, reinforcing agents and combinations thereof.

All of the additives described above may be used in an effective amount customary for these substances. The non-flame retardants additives may be used in amounts of from about 0 to about 30 weight percent, in one embodiment from about 0.1 to about 25 weight percent, and in another embodiment about 0.1 to about 20 weight percent of the total weight of the TPU composition.

These additional additives can be incorporated into the components of, or into the reaction mixture for, the preparation of the TPU resin, or after making the TPU resin. In another process, all the materials can be mixed with the TPU resin and then melted or they can be incorporated directly into the melt of the TPU resin.

### Industrial Application

In some embodiments, the present invention provides TPU compositions that have improved processing windows. The stickiness and/or tackiness is one aspect of processing, but there are others as well. Many TPU compositions have very narrow processing windows, a very tight set of conditions under which they process well. Sometimes, just slightly increasing the throughput of an extruder can change the processing conditions enough that a given TPU shifts out of its processing window and the product process suffers. As noted above, there is a need to improve the overall processability of TPU compositions, to broaden the TPU composition's processing window, making it less sensitive to processing changes, and so improving the quality of the final material (more uniform TPU, less deviances across a lot of materials that can be caused by slight changes in processing conditions, etc.). Stickiness and similar properties make it much harder to process TPU compositions, and at some point the processing issues become so great that the TPU composition cannot be processed effectively. This point where the TPU composition is not processable may generally include the point where the product coming from the process is not uniform in quality or production rate, where the production equipment becomes repeatedly blocked and/or impaired by material build-up, and/or where the product sticks to the equipment to the extent that it cannot be handled, collected, further processes and packaged, and/or sampled, etc. These processing problems have been a significant barrier to producing ultra-soft TPU.

By reducing the stickiness of the TPU composition, the processing window for these materials can be greatly improved, that is the processing conditions under which these TPU compositions can be successfully processed without being overwhelmed by the problems and challenges described above. Providing a TPU composition, in some embodiments without using a plasticizer, that can be processed in “normal” way is a significant step forward and will allow the commercialization of TPU compositions, including ultra-soft TPU compositions, which previously could not be processed successfully or at least consistently well. Another way to describe the improvement provided by the invention is to say the TPU compositions of the invention have improved extrudability and/or that they experience less or even no sticking. In some embodiments, the TPU compositions of the invention can be processed in commercial scale continuous extruders, whereas the corresponding non-inventive TPU composition cannot be (results in a TPU composition that cannot be tested and/or is unsuitable for the desired application). In addition, completely amorphous (no crystallization point) TPU, like some polycarbonate TPU, have a high degree of phase mixing and so longer solidification times resulting in significant processing issues such as tackiness when this material is extruded into sheet or tubing. Such materials can be very difficult to polymerize on a commercial scale (in a continuous extruder) and would be very difficult to further process into finished articles (via extruding, molding, etc). The compositions of the invention solve this problem. The invention compositions will have sharp Tc transitions, and significantly reduced and even eliminated tackiness issues when extruded into sheet.

The more processable TPU compositions of the invention may be described as TPU composition comprising the reaction product of (i) a polyisocyanate component, (ii) at least one of a chain extender component and a polyol component, and (iii) the described chain terminator component. While not wishing to be bound by theory, it is believed that the presence of the described chain terminator component acts to reduce the negative limitations described above, improving the processability, and so broadening the processing window of the resulting TPU.

In some embodiments, these processes use soft dimer acid based glycols and/or polycarbonate glycols to produce the TPU. These TPU's are amorphous and tend to stick to equipment and even block equipment during processing. In some embodiments, the process involves adding a chain terminator component to the reaction mixture, which will result in a reduction in the amount of sticking and/or blocking seen in the processing equipment.

In some embodiments, a polyol component makes up at least 75 percent by weight of the TPU reaction mixture. In other embodiments, the polyol component makes up at least 77, 78, 79, 80 or even 90 percent by weight of the TPU reaction mixture.

In one embodiment, the soft segment materials (the polyol and/or the chain extender) make up at least 75 percent by weight of the TPU reaction mixture. In other embodiments, the soft segment materials makes up at least 77, 78, 79, 80 or even 90 percent by weight of the TPU reaction mixture.

The invention includes the plasticizer-free ultra-soft TPU compositions with reduced stickiness and/or improved processability described above, and the process of making the same.

The invention also provides the method of making these TPU compositions with improved processability windows. In both the compositions and the processes of making them, in some embodiments the polyol component makes up at least 75 percent by weight of the thermoplastic polyurethane reaction mixture. In some embodiments, the TPU compositions with improved processability windows is a TPU based on amorphous polyols or TPU with amorphous morphologies. These can include TPU made from dimer fatty acid based polyols (amorphous polyols) and/or aliphatic TPU or aromatic polycarbonate-based TPU (TPU with amorphous morphologies). In some embodiments, the TPU of the compositions of the invention are amorphous aromatic TPU (for example, they are made with an aromatic diisocyanate). In other embodiments, the TPU of the compositions of the invention are amorphous aliphatic TPU (for example they are made with an aliphatic diisocyanate). In some embodiments, the amorphous aliphatic TPU are made without the use of a chain extender. In some embodiments, the amorphous aliphatic TPU are polyester and/or polycarbonate TPUs and can be made without the use of a polyether polyol.

In some embodiments, these TPU compositions with improved processability windows are made from a diisocyanate, a polycarbonate polyol, a diol chain extender, along with the short chain crystalline chain terminator. In some embodiments, these TPU compositions with improved processability windows are made from a diisocyanate, a polycarbonate polyol, a diol chain extender, along with the short chain crystalline chain terminator.

In some embodiments, the present invention provides TPU compositions that are ultra-soft. By ultra-soft it is meant that the TPU and/or the TPU composition have a Shore hardness below 65 A with no plasticizer. As noted above, there are currently practical limits on how soft a commercial TPU can be, as conventional methods of making softer TPU compositions also result in materials that are very tacky and difficult to process. In addition, soft TPU tends to start losing its strength and so has poor physical properties. These limits have severely inhibited the commercial production and use of ultra-soft TPU compositions. In some embodiments, the present invention provides improved TPU compositions and methods of making TPU compositions that provide ultra-soft properties while avoiding these limitations.

The ultra-soft TPU compositions of the invention may be described as TPU composition comprising the reaction product of (i) a polyisocyanate component, (ii) at least one of a chain extender component and a polyol component, and (iii) the described chain terminator component. While not wishing to be bound by theory, it is believed that the presence of the described chain terminator component acts to reduce the negative limitations described above, allowing an ultra-soft TPU composition to be processed while maintaining its other physical properties. Any of the TPU reaction mixtures and/or TPU compositions may be used and/or modified by this process.

In some embodiments, the ultra-soft TPU composition has a Shore hardness below 65 A. In some of these embodiments the hardness level is achieved without the use of a plasticizer (the TPU composition may be free of any plasticizer).

In some embodiments, the TPU composition is prepared from polyisocyanate component that includes a diisocyanate, a chain extender component that includes a diol; and a polyol component, when present, that includes a polyether polyol, a polyester polyol, or a combination thereof. In some embodiments, the ultra-soft TPU compositions are made from a diisocyanate, a polyether and/or polyester polyol, and optionally a diol chain extender, along with the short chain crystalline chain terminator. In some embodiments, the ultra-soft TPU compositions are made from a diisocyanate and a polyether polyol, along with the short chain crystalline chain terminator. In some embodiments, the ultra-soft TPU compositions are made from a diisocyanate, a polyester polyol, and a diol chain extender, along with the short chain crystalline chain terminator.

In some embodiments, the present invention provides TPU compositions that are further modified by grafting a vinyl alkoxysilane moiety onto the TPU chains. This may be completed in the presence of a peroxide. In some embodiments, the grafting step is completed after the formation of the TPU, that is, after the reaction of the components that result in the TPU. Any of the TPU compositions described herein may be grafted with these moieties, resulting in a vinyl alkoxysilane grafted TPU composition. The vinyl alkoxysilane grafted TPU composition may then be easily cross-linked, resulting in a cross-linked TPU network where the crosslinking bonds are siloxane bridges that may be formed by the hydrolysis and subsequent condensation of the alkoxysilane groups. Any of the TPU reaction mixtures and/or TPU compositions may be used and/or modified by this process.

The invention includes the vinyl alkoxysilane grafted TPU compositions described above, the siloxane cross-linked TPU networks formed from such compositions, and the process of making the same. The invention includes the process of making the vinyl alkoxysilane grafted TPU compositions as well as the process of crosslinking such compositions through the hydrolysis of the vinyl alkoxysilane groups, resulting in the cross-linked TPU network described herein. In some embodiments, the polyol used to make these vinyl alkoxysilane grafted TPU has a molecular weight of from 1000 to 2000. In some embodiments, these vinyl alkoxysilane grafted TPU are polyether TPU.

In some embodiments, the present invention provides TPU compositions that have reduced surface tension, which is believed to provide enhance compatibility of the TPU composition with other polymers, particularly polyolefins. Thus, the described TPU compositions provide improved blends with other polymers, particularly non-polar polymers including polyolefins, due to this increased compatibility, resulting in improved physical processing characteristics and physical properties of such blends.

In some embodiments, the polymers used in these blends are polyolefins, for example polypropylene, polyethylene, copolymers of propylene and ethylene, or combinations thereof. In some embodiments the blends have a weight ratio of from 1:99 to 99:1, or from 1:9 to 9:1, or from 2:1 to 1:2, or even about 1:1 parts modified TPU compositions to parts polymer, for example polyolefin.

Thus the invention provides a method of reducing the surface tension of a TPU composition said method including the step of: (I) adding the described chain terminator component to the TPU reaction mixture. The resulting TPU has a surface tension lower than that of a corresponding TPU made without the chain terminator component. In some embodiments, the TPU reaction mixture includes a polyisocyanate component that includes a diisocyanate, a chain extender component that includes a diol, and a polyol component that includes a polyether polyol.

The invention also includes the improved blends made using the described TPU compositions and one or more other polymers, in some embodiments one or more polyolefins. The invention also includes the improved blends made using the described TPU compositions and one or more other polymers, in some embodiments one or more polyolefins. The invention also includes articles made from the described TPU compositions. These articles include films, sheets, non-woven fabrics, and various other articles, where the article is made from the described TPU compositions, and even when the article is made from the described blends. In some embodiments, the TPU compositions with reduced surface tension are made from a diisocyanate, a polyether polyol, and a diol chain extender, along with the short chain crystalline chain terminator.

In some embodiments, the present invention provides TPU compositions that can be readily cross-linked without an additional step of grafting, or some other similar modification. Such an improvement would allow cross-linked TPU networks to be formed much more easily and cheaply, as generally some other step is required (the addition of a cross-linker, the grafting of a cross-linkable group onto the TPU, etc.) is required to provide a cross-linked TPU network.

For such crosslinking to be possible, the chain extender component used to prepare the TPU must have some chain extender material that contains one or more carbon-carbon double bonds. In some embodiments, these chain extenders are glycol chain extenders containing carbon-carbon double bonds, and they are generally used in combination with one or more saturated glycol chain extenders. The glycol chain extender used in making the thermoplastic polyurethane of this invention will be a combination of a saturated glycol chain extender and glycol chain extender containing carbon-carbon double bonds (unsaturated glycol chain extender). The unsaturated glycol chain extender will typically represent about 2 weight percent to about 25 weight percent of the total amount of chain extender utilized in synthesizing the TPU of this invention. The total amount of chain extender is, of course, the sum of the total amount of saturated glycol and unsaturated glycol used in making the TPU. Thus, in this scenario, the unsaturated glycol chain extender will represent about 2 to about 25 weight percent and the saturated glycol chain extender will represent about 75 to about 98 weight percent of the total chain extender utilized. The unsaturated glycol chain extender may represent 5 to 50, or 8 to 50 weight percent of the total chain extender utilized. The unsaturated glycol will normally represent from about 0.8 to about 10, or 1 to 4, or 1.5 to 3 weight percent of the total weight of the TPU (total weight of hydroxyl terminated intermediate, polyisocyanate, saturated glycol chain extender, and unsaturated glycol chain extender). The saturated chain extender that can be used in synthesizing the TPUs of this invention include organic diols or glycols having from 2 to about 20 carbon atoms, such as alkane diols, including any of the materials described above. Mixtures of the above noted chain extenders can also be utilized. Such materials and their use in more conventional TPU are described in detail is US patent application publication number 2011/0186329, incorporated herein by reference.

Thus the invention provides a method of making a TPU composition cross-linkable by UV, E-beam or gamma-beam irradiation, said method including the step of: (I) adding the described chain terminator component, and optionally a photoinitiator, to a TPU reaction mixture. This results in a TPU that is cross-linkable by UV (when the photoinitiator is present), E-Beam or gamma-beam irradiation. The invention also provides the method of cross-linking the cross-linkable TPU composition and the resulting cross-linked TPU network.

The photoinitiator is necessary for the UV crosslinking but is optional for E-beam and/or gamma-beam crosslinking Any of the TPU reaction mixtures and/or TPU compositions may be used and/or modified by this process.

In some embodiments, the cross-linkable TPU composition and/or the cross-linked TPU network are made from a diisocyanate, a polycarbonate and/or polyether polyol, and a diol chain extender, along with the short chain crystalline chain terminator.

### Processing

The compositions of the invention may be processed by any suitable means such as by calendering, casting, coating, compounding, extrusion, foaming, laminating, blow molding, compression molding, injection molding, thermoforming, transfer molding, cast molding, rotational molding, casting such as for films, spun or melt bonded such as for fibers, or other forms of processing such as described in, for example, PLASTICS PROCESSING (Radian Corporation, Noyes Data Corp. 1986).

In some embodiments, the articles of the invention may be formed and/or processed by calendaring. In some embodiments, the articles of the invention may be formed and/or processed by casting. In some embodiments, the articles of the invention may be formed and/or processed by coating. In some embodiments, the articles of the invention may be formed and/or processed by compounding. In some embodiments, the articles of the invention may be formed and/or processed by extrusion. In some embodiments, the articles of the invention may be formed and/or processed by foaming. In some embodiments, the articles of the invention may be formed and/or processed by laminating. In some embodiments, the articles of the invention may be formed and/or processed by blow molding. In some embodiments, the articles of the invention may be formed and/or processed by compression molding. In some embodiments, the articles of the invention may be formed and/or processed by injection molding. In some embodiments, the articles of the invention may be formed and/or processed by thermoforming. In some embodiments, the articles of the invention may be formed and/or processed by transfer molding. In some embodiments, the articles of the invention may be formed and/or processed by cast molding. In some embodiments, the articles of the invention may be formed and/or processed by rotational molding. In some embodiments, the articles of the invention may be formed and/or processed by casting such as for films. In some embodiments, the articles of the invention may be formed and/or processed by spun or melt bonded such as for fibers. In some embodiments, an article is formed and/or processed by more than one of the means described above.

More particularly, with respect to the physical process of producing a blend utilizing the compositions of the invention, sufficient mixing should take place to assure that a uniform blend will be produced prior to conversion into a finished product. Such blends can be prepared in any number of ways. The compositions of the invention to be used in such blends can be in any physical form. In one embodiment, the compositions of the invention are in the form of reactor granules, defined as the granules of polymer that are isolated from the polymerization reactor prior to any processing procedures. The reactor granules have an average diameter of from 50 μm to 10 mm in one embodiment, and from 10 μm to 5 mm in another embodiment. In another embodiment, the compositions of the invention are in the form of pellets, such as, for example, having an average diameter of from 1 mm to 10 mm that are formed from melt extrusion of the reactor polymer or granules.

The compositions of the invention and any other ingredients can be blended by any suitable means, and are typically blended to obtain a homogeneous mixture. For example, they may be blended in a tumbler, static mixer, batch mixer, extruder, or a combination thereof. The mixing step may take place as part of a processing method used to fabricate articles, such as in the extruder of an injection molding machine or fiber line.

The mixing step may involve first dry blending using, for example, a tumble blender, where compositions of the invention and any other blend components or additives to be added thereto are brought into contact first, without intimate mixing, which may then be followed by melt blending in an extruder. Another method of blending the components is to melt blend the compositions of the invention with any other blend components or additives directly in an extruder or batch mixer, such as a “Banbury” mixer. In a preferred method, it involves a “master batch” approach, where a target additive and/or component concentration is achieved by adding compositions of the invention previously prepared at a higher additive and/or component concentration to neat compositions of the invention in the appropriate ratio. The mixing step may take place as part of a processing method used to fabricate articles, such as in the extruder on an injection molding, film, or fiber line.

In one aspect of the invention, the compositions of the invention are “melt blended” in an apparatus such as an extruder (single or twin screw) or batch mixer. The compositions of the invention may also be “dry blended” with the NFP using a tumbler, double-cone blender, ribbon blender, or other suitable blender. In yet another embodiment, the composition of the invention are blended by a combination of approaches, for example, a tumbler followed by an extruder. A preferred method of blending is to include the final stage of blending as part of an article fabrication step, such as in the extruder used to melt and convey the composition for a molding step like injection molding or blow molding. This could include direct injection of an additive and/or blend component into the extruder, either before or after the melt zone. Extrusion technology is described in, for example, PLASTICS EXTRUSION TECHNOLOGY 26-37 (Friedhelm Hensen, ed. Hanser Publishers 1988).

In another aspect of the invention, the composition may be blended in solution by any suitable means using a solvent that dissolves the compositions of the invention and/or the additive and/or blend component to be added to a significant extent. The blending may occur at any temperature or pressure where the compositions of the invention and/or additive and/or blend component remain in solution. It may also occur under conditions where the compositions of the invention remain in solution, but the additive and/or blend component does not.

### Articles

The compositions of the invention any blends thereof are useful in a wide variety of applications, including transparent articles such as cook and storage ware, and in other articles such as furniture, automotive components, toys, sportswear, medical devices, sterilizable medical devices, sterilization containers, fibers, woven fabrics, nonwoven fabrics, drapes, gowns, filters, hygiene products, diapers, and films, oriented films, sheets, tubes, pipes, wire jacketing, cable jacketing, agricultural films, geomembranes, sporting equipment, cast film, blown film, profiles, boat and water craft components, and other such articles. The compositions are suitable for automotive components such as bumpers, grills, trim parts, dashboards and instrument panels, exterior door and hood components, spoiler, wind screen, hub caps, mirror housing, body panel, protective side molding, and other interior and external components associated with automobiles, trucks, boats, and other vehicles.

Other useful articles and goods may be formed from the compositions of the invention including: crates, containers, packaging, labware, such as roller bottles for culture growth and media bottles, office floor mats, instrumentation sample holders and sample windows; liquid storage containers such as bags, pouches, and bottles for storage and IV infusion of blood or solutions; packaging material including those for any medical device or drugs including unit-dose or other blister or bubble pack as well as for wrapping or containing food preserved by irradiation. Other useful items include medical tubing and valves for any medical device including infusion kits, catheters, and respiratory therapy, as well as packaging materials for medical devices or food which is irradiated including trays, as well as stored liquid, particularly water, milk, or juice, containers including unit servings and bulk storage containers as well as transfer means such as tubing, hoses, pipes, and such, including liners and/or jackets thereof. In some embodiments, the articles of the invention are fire hoses that include a liner made from the TPU compositions described herein. In some embodiments, the liner is a layer applied to the inner jacket of the fire hose.

Still additional useful articles and goods may be formed from the compositions of the invention including: a sheet, a tape, a carpet, an adhesive, a wire sheath, a cable, a protective apparel, an automotive part, a footwear component, a coating, or a foam laminate, an overmolded article, an automotive skin, an awning, a tarp, a leather article, a roofing construction article, a steering wheel, a powder coating, a powder slush molding, a consumer durable, a grip, a handle, a hose, a hose liner, a pipe, a pipe liner, a caster wheel, a skate wheel, a computer component, a belt, an applique, a footwear component, a conveyor or timing belt, a glove (made from one or more of the films described herein, or made from one or more of the fabrics described herein), a fiber, a fabric, or a garment.

In another embodiment, the article is a tie layer between extruded sheets, a tie layer between extruded films, a tie layer between extruded profiles, a tie layer between cast sheets, tie layer between cast films, a tie layer between cast profiles, or a tie layer between a combination of the aforementioned.

These article and/or devices may be made or formed by any useful forming means for forming polyolefins or other polymeric materials. This will include, at least, molding, including compression molding, injection molding, blow molding, and transfer molding; film blowing or casting; extrusion, and thermoforming; as well as by lamination, pultrusion, protrusion, draw reduction, rotational molding, spinbonding, melt spinning, melt blowing; or combinations thereof. Use of at least thermoforming or film applications allows for the possibility of and derivation of benefits from uniaxial or biaxial orientation of the material.

### Films

The compositions of the invention and any blends thereof may be formed into monolayer or multilayer films, including breathable films. These films may be formed by any of the conventional techniques known in the art including extrusion, co-extrusion, extrusion coating, lamination, blowing and casting. The film may be obtained by the flat film or tubular process which may be followed by orientation in an uniaxial direction or in two mutually perpendicular directions in the plane of the film. One or more of the layers of the film may be oriented in the transverse and/or longitudinal directions to the same or different extents. This orientation may occur before or after the individual layers are brought together. Typically the films are oriented in the Machine Direction (MD) at a ratio of up to 15, preferably between 5 and 7, and in the Transverse Direction (TD) at a ratio of up to 15 preferably 7 to 9. However in another embodiment, the film is oriented to the same extent in both the MD and TD directions.

In another embodiment, the layer comprising the compositions of this invention or any blends thereof may be combined with one or more other layers. The other layer(s) may be any layer typically included in multilayer film structures. For example, the other layer or layers may be: (i) Polyolefins: suitable polyolefins include homopolymers or copolymers of C2 to C40 olefins, preferably C2 to C20 olefins, preferably a copolymer of an alpha-olefin and another olefin or alpha-olefin (ethylene is defined to be an alpha-olefin for purposes of this invention). Suitable polyolefins also include homopolyethylene, homopolypropylene, propylene copolymerized with ethylene and or butene, ethylene copolymerized with one or more of propylene, butene or hexene, and optional dienes. Suitable examples include thermoplastic polymers such as ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and blends of thermoplastic polymers and elastomers, such as for example, thermoplastic elastomers and rubber toughened plastics; (ii) Polar Polymers: suitable polar polymers include homopolymers and copolymers of esters, amides, actates, anhydrides, copolymers of a C2 to C20 olefin, such as ethylene and/or propylene and/or butene with one or more polar monomers such as acetates, anhydrides, esters, alcohol, and or acrylics. Preferred examples include polyesters, polyamides, ethylene vinyl acetate copolymers, and polyvinyl chloride; (iii) Cationic Polymers: suitable cationic polymers include polymers or copolymers of geminally disubstituted olefins, alpha-heteroatom olefins and/or styrenic monomers. Preferred geminally disubstituted olefins include isobutylene, isopentene, isoheptene, isohexane, isooctene, isodecene, and isododecene. Suitable alpha-heteroatom olefins include vinyl ether and vinyl carbazole, preferred styrenic monomers include styrene, alkyl styrene, para-alkyl styrene, alpha-methyl styrene, chloro-styrene, and bromo-para-methyl styrene. Suitable examples of cationic polymers include butyl rubber, isobutylene copolymerized with para methyl styrene, polystyrene, and poly-alpha-methyl styrene; (iv) Miscellaneous: other suitable layers can be paper, wood, cardboard, metal, metal foils (such as aluminum foil and tin foil), metallized surfaces, glass (including silicon oxide (SiOx) coatings applied by evaporating silicon oxide onto a film surface), fabric, spunbonded fibers, and nonwovens (particularly polypropylene spun bonded fibers or nonwovens), and substrates coated with inks, dyes, pigments, and the like.

The films may vary in thickness depending on the intended application, however, films of a thickness from 1 to 250 μm are usually suitable. Films intended for packaging are usually from 10 to 60 micron thick. The thickness of the sealing layer is typically 0.2 to 50 μm. There may be a sealing layer on both the inner and outer surfaces of the film or the sealing layer may be present on only the inner or the outer surface.

Additives such as block, antiblock, antioxidants, pigments, fillers, processing aids, UV stabilizers, neutralizers, lubricants, surfactants and/or nucleating agents may also be present in one or more than one layer in the films. Suitable additives include silicon dioxide, titanium dioxide, polydimethylsiloxane, talc, dyes, wax, calcium sterate, carbon black, low molecular weight resins and glass beads.

In another embodiment, one more layers may be modified by corona treatment, electron beam irradiation, gamma irradiation, or microwave irradiation. In a preferred embodiment one or both of the surface layers is modified by corona treatment.

The films described herein may also comprise from 5 to 60 weight %, based upon the weight of the polymers and the resin, of a hydrocarbon resin. The resin may be combined with the polymer of the seal layer(s) or may be combined with the polymer in the core layer(s). The resin may have a softening point above 100° C. or even from 130 to 180° C. Preferred hydrocarbon resins include those described above. The films comprising a hydrocarbon resin may be oriented in uniaxial or biaxial directions to the same or different degrees.

The films described above may be used as stretch and/or cling films. Stretch/cling films are used in various bundling, packaging and palletizing operations.

The invention also provides a film comprising at least one layer formed from an inventive composition. In another embodiment, the invention provides a film comprising at least two layers, and wherein at least one layer is formed from an inventive composition. In another embodiment, an inventive film has a moisture vapor transmission rate of at least 7 g/hr/ft².

The invention also provides an extruded sheet formed from an inventive composition. In a further embodiment, the sheet has a surface energy greater than, or equal to, 30 dyne/cm, preferably greater than, or equal to, 33 dyne/cm, more preferably greater than, or equal to 35 dyne/cm. In another embodiment, the sheet has a thickness from 10 mils to 1000 mils, preferably from 15 mils to 500 mils, and more preferably from 20 mils to 100 mils. In another embodiment, the sheet maintains at least 50 percent, preferably at least 60 percent, of its original elongation after heat aging at 120° C. for 500 hours (ASTM D-882-02).

### Molded Products

The compositions of the invention or any blends thereof may also be used to prepare the molded products of this invention in any molding process, including but not limited to, injection molding, gas-assisted injection molding, extrusion blow molding, injection blow molding, injection stretch blow molding, compression molding, rotational molding, foam molding, thermoforming, sheet extrusion, and profile extrusion. The molding processes are well known to those of ordinary skill in the art.

The compositions may be shaped into desirable end use articles by any suitable means known in the art. Thermoforming, vacuum forming, blow molding, rotational molding, slush molding, transfer molding, wet lay-up or contact molding, cast molding, cold forming matched-die molding, injection molding, spray techniques, profile co-extrusion, or combinations thereof are typically used methods.

Thermoforming is a process of forming at least one pliable plastic sheet into a desired shape. An embodiment of a thermoforming sequence is described; however, this should not be construed as limiting thermoforming methods useful with the compositions of this invention. First, an extrudate film of the composition of this invention (and any other layers or materials) is placed on a shuttle rack to hold it during heating. The shuttle rack indexes into the oven which pre-heats the film before forming. Once the film is heated, the shuttle rack indexes back to the forming tool. The film is then vacuumed onto the forming tool to hold it in place and the forming tool is closed. The forming tool can be either “male” or “female” type tools. The tool stays closed to cool the film and the tool is then opened. The shaped laminate is then removed from the tool.

Thermoforming is accomplished by vacuum, positive air pressure, plug-assisted vacuum forming, or combinations and variations of these, once the sheet of material reaches thermoforming temperatures, typically of from 140° C. to 185° C. or higher. A pre-stretched bubble step is used, especially on large parts, to improve material distribution. In one embodiment, an articulating rack lifts the heated laminate towards a male forming tool, assisted by the application of a vacuum from orifices in the male forming tool. Once the laminate is firmly formed about the male forming tool, thermoformed shaped laminate is then cooled, typically by blowers. Plug-assisted forming is generally used for small, deep drawn parts. Plug material, design, and timing can be critical to optimization of the process. Plugs made from insulating foam avoid premature quenching of the plastic. The plug shape is usually similar to the mold cavity, but smaller and without part detail. A round plug bottom will usually promote even material distribution and uniform side-wall thickness. For a semicrystalline polymer such as polypropylene, fast plug speeds generally provide the best material distribution in the part.

The shaped laminate is then cooled in the mold. Sufficient cooling to maintain a mold temperature of 30° C. to 65° C. is desirable. The part is below 90° C. to 100° C. before ejection in one embodiment. For the good behavior in thermoforming, the lowest melt flow rate polymers are desirable. The shaped laminate is then trimmed of excess laminate material.

Blow molding is another suitable forming means, which includes injection blow molding, multi-layer blow molding, extrusion blow molding, and stretch blow molding, and is especially suitable for substantially closed or hollow objects, such as, for example, gas tanks and other fluid containers. Blow molding is described in more detail in, for example, CONCISE ENCYCLOPEDIA OF POLYMER SCIENCE AND ENGINEERING 90-92 (Jacqueline I. Kroschwitz, ed., John Wiley & Sons 1990).

In yet another embodiment of the formation and shaping process, profile co-extrusion can be used. The profile co-extrusion process parameters are as above for the blow molding process, except the die temperatures (dual zone top and bottom) range from 150 to 235° C., the feed blocks are from 90 to 250° C., and the water cooling tank-temperatures are from 10 to 40° C.

One embodiment of an injection molding process is described as follows. The shaped laminate is placed into the injection molding tool. The mold is closed and the substrate material is injected into the mold. The substrate material has a melt temperature between 200 and 300° C. in one embodiment, and from 215 and 250° C. in another embodiment is injected into the mold at an injection speed of between 2 and 10 seconds. After injection, the material is packed or held at a predetermined time and pressure to make the part dimensionally and aesthetically correct. Typical time periods are from 5 to 25 seconds and pressures from 1,380 to 10,400 kPa. The mold is cooled between 10 and 70° C. to cool the substrate. The temperature will depend on the desired gloss and appearance desired. Typical cooling time is from 10 to 30 seconds, depending on part on the thickness. Finally, the mold is opened and the shaped composite article ejected.

Likewise, molded articles may be fabricated by injecting molten polymer into a mold that shapes and solidifies the molten polymer into desirable geometry and thickness of molded articles. Sheet may be made either by extruding a substantially flat profile from a die, onto a chill roll, or alternatively by calendaring. Sheet will generally be considered to have a thickness of from 10 mils to 100 mils (254 μm to 2540 μm), although sheet may be substantially thicker. Tubing or pipe may be obtained by profile extrusion for uses in medical, potable water, land drainage applications or the like. The profile extrusion process involves the extrusion of molten polymer through a die. The extruded tubing or pipe is then solidified by chill water or cooling air into a continuous extruded articles. The tubing will generally be in the range of from 0.31 cm to 2.54 cm in outside diameter, and have a wall thickness of in the range of from 254 μm to 0.5 cm. The pipe will generally be in the range of from 2.54 cm to 254 cm in outside diameter, and have a wall thickness of in the range of from 0.5 cm to 15 cm. Sheet made from the products of an embodiment of a version of the present invention may be used to form containers. Such containers may be formed by thermoforming, solid phase pressure forming, stamping and other shaping techniques. Sheets may also be formed to cover floors or walls or other surfaces.

In an embodiment of thermoforming process, the oven temperature is between 160 and 195° C., the time in the oven between 10 and 20 seconds, and the die temperature, typically a male die, between 10 and 71° C. The final thickness of the cooled (room temperature), shaped laminate is from 10 μm to 6000 μm in one embodiment, from 200 μm to 6000 μm in another embodiment, and from 250 μm to 3000 μm in yet another embodiment, and from 500 μm to 1550 μm in yet another embodiment, a desirable range being any combination of any upper thickness limit with any lower thickness limit.

In an embodiment of the injection molding process, wherein a substrate material is injection molded into a tool including the shaped laminate, the melt temperature of the substrate material is between 230 and 255° C. in one embodiment, and between 235 and 250° C. in another embodiment, the fill time from 2 to 10 seconds in one embodiment, from 2 to 8 seconds in another embodiment, and a tool temperature of from 25 to 65° C. in one embodiment, and from 27 and 60° C. in another embodiment. In a desirable embodiment, the substrate material is at a temperature that is hot enough to melt any tie-layer material or backing layer to achieve adhesion between the layers.

In yet another embodiment of the invention, the compositions of this invention may be secured to a substrate material using a blow molding operation. Blow molding is particularly useful in such applications as for making closed articles such as fuel tanks and other fluid containers, playground equipment, outdoor furniture and small enclosed structures. In one embodiment of this process, compositions of this invention are extruded through a multi-layer head, followed by placement of the uncooled laminate into a parison in the mold. The mold, with either male or female patterns inside, is then closed and air is blown into the mold to form the part.

It will be understood by those skilled in the art that the steps outlined above may be varied, depending upon the desired result. For example, an extruded sheet of the compositions of this invention may be directly thermoformed or blow molded without cooling, thus skipping a cooling step. Other parameters may be varied as well in order to achieve a finished composite article having desirable features.

The invention also provides an over-molded article comprising the following: (a) a substrate formed from a composition comprising a polar polymer, and (b) a molded overlay formed from an inventive composition. In one embodiment, the polar polymer is a polycarbonate (PC), ABS, PC/ABS, or nylon. The invention also provides an over-molded article comprising the following: (a) a substrate formed from an inventive composition, and (b) a molded overlay formed from a composition comprising a polar polymer. In one embodiment, the article is in the form of a grip, handle or belt.

The invention also provides a laminated structure comprising a first layer and a second layer, and wherein the first layer is formed from an inventive composition, and wherein the second layer is formed from a composition comprising a polar polymer. In another embodiment, one of the layers is in the form of a foam. In another embodiment, one of the layers is in the form of a fabric. In another embodiment, the laminated structure is in the form of an awning, tarp or automobile skin or steering wheel. In another embodiment, the second layer is formed from a composition comprising a polycarbonate.

The invention also provides a molded article comprising a first component and a second component, and wherein the first component is formed from a composition comprising a polar polymer, and wherein the second component is formed from an inventive composition. In another embodiment, the article is in the form of an automobile skin, an applique, a footwear component, a conveyor belt, a timing belt or a consumer durable.

### Fibers and Fabrics

The compositions of the invention or any blends thereof may also be used to prepare nonwoven fabrics, woven fabrics, and fibers in any nonwoven and/or woven fabric and fiber making process, including but not limited to, melt blowing, spunbonding, film aperturing, and staple fiber carding. A continuous filament process may also be used. Preferably a spunbonding process is used. The spunbonding process is well known in the art. Generally it involves the extrusion of fibers through a spinneret. These fibers are then drawn using high velocity air and laid on an endless belt. A calender roll is generally then used to heat the web and bond the fibers to one another although other techniques may be used such as sonic bonding and adhesive bonding.

The fibers of the invention may be monofilament or multifilament. In some embodiments, the fibers of the invention are monofilament fibers.

Fiber Preparation.

The formation of woven and nonwoven articles from the compositions of the invention typically requires the manufacture of fibers by extrusion followed by weaving or bonding. The extrusion process is typically accompanied by mechanical or aerodynamic drawing of the fibers. Essentially all fibers are oriented both during the extrusion process as well as during the process of manufacture of the nonwoven article.

Conventional Fine Denier PP Fibers.

The three more conventional fiber operations, continuous filament, bulked continuous filament, and staple, are useful as means for preparing fibers of the blends of the present invention. Typically the molten blend is extruded through the holes in a die (spinneret) between 0.3 mm to 0.8 mm (10 mil to 30 mil) in diameter. Low melt viscosity of the polymer blend is preferred and is typically achieved through the use of high melt temperature (230 to 280° C.) and high melt flow rates (15 g/l 10 min to 40 g/l 10 min). A relatively large extruder is typically equipped with a manifold to distribute a high output of molten blend to a bank of eight to twenty spinnerets. Each spinhead is typically equipped with a separate gear pump to regulate output through that spinhead; a filter pack, supported by a “breaker plate;” and the spinneret plate within the head. The number of holes in the spinneret plate determines the number of filaments in a yarn and varies considerably with the different yarn constructions, but it is typically in the range of 50 to 250. The holes are typically grouped into round, annular, or rectangular patterns to assist in good distribution of the quench air flow.

Continuous Filament.

Continuous filament yarns typically range from 40 denier to 2,000 denier (denier means the number of grams per 9000 meters). Filaments typically range from 1 to 20 denier per filament (dpf), but can be larger. Spinning speeds are typically 800 m/min to 1500 m/min (2500 ft/min to 5000 ft/min). The filaments are drawn at draw ratios of 3:1 or more (one- or two-stage draw) and wound onto a package. Two-stage drawing allows higher draw ratios to be achieved. Winding speeds are 2,000 m/min to 3,500 m/min (6,600 ft/min to 11,500 ft/min). Spinning speeds in excess of 900 m/min (3000 ft/min) require a narrow molecular weight distribution (NMWD) to get the best spinnability with the finer filaments.

Bulked Continuous Filament.

Bulked Continuous Filament (CF) fabrication processes fall into two basic types, one-step and two step. In the older, two-step process, an undrawn yarn is spun at less than 1,000 m/min (3,300 ft/min), usually 750 m/min, and placed on a package. The yarn is drawn (usually in two stages) and “bulked” on a machine called a texturizer. Winding and drawing speeds are limited by the bulking or texturizing device to 2,500 m/min (8,200 ft/min) or less. Typically, if secondary crystallization occurs in the two-step CF process, then one typically promptly uses draw texturizing. The most common process today is the one-step spin/draw/text (SDT) process. This process provides better economics, efficiency and quality than the two-step process. It is similar to the one-step CF process, except that the bulking device is in-line. Bulk or texture changes yarn appearance, separating filaments and adding enough gentle bends and folds to make the yarn appear fatter (bulkier).

Staple Fiber.

There are two basic staple fiber fabrication processes: traditional and compact spinning. The traditional process involves two steps: 1) producing, applying finish, and winding followed by 2) drawing, a secondary finish application, crimping, and cutting into staple. Filaments can range from 1.5 dpf to >70 dpf, depending on the application. Staple length can be as short as 7 mm or as long as 200 mm (0.25 in. to 8 in.) to suit the application. For many applications the fibers are crimped. Crimping is accomplished by over-feeding the tow into a steam-heated stuffer box with a pair of nip rolls. The over-feed folds the tow in the box, forming bends or crimps in the filaments. These bends are heat-set by steam injected into the box.

Melt-Blown Fibers.

Melt blown fibers can make very fine filaments and produce very lightweight fabrics with excellent uniformity. The result is often a soft fabric with excellent “barrier” properties. In the melt blown process molten polymer moves from the extruder to the special melt blowing die. As the molten filaments exit the die, they are contacted by high temperature, high velocity air (called process or primary air). This air rapidly draws and, in combination with the quench air, solidifies the filaments. The entire fiber forming process generally takes place within 7 mm (0.25 in.) of the die. The fabric is formed by blowing the filaments directly onto a forming wire, 200 mm to 400 mm (8 in. to 15 in.) from the spinnerets.

Melt blown microfibers useful in the present invention can be prepared as described in Van A. Wente, “Superfine Thermoplastic Fibers,” Industrial Engineering Chemistry, vol. 48, pp. 1342-1346 and in Report No. 4364 of the Naval Research Laboratories, published May 25, 1954, entitled “Manufacture of Super Fine Organic Fibers” by Van A. Wente et al. In some preferred embodiments, the microfibers are used in filters. Such blown microfibers typically have an effective fiber diameter of from about 3 to 30 micrometers preferably from about 7 to 15 micrometers, as calculated according to the method set forth in Davies, C. N., “The Separation of Airborne Dust and Particles,” Institution of Mechanical Engineers, London, Proceedings 1B, 1952.

Spunbonded Fibers.

Fiber formation may also be accomplished by extrusion of the molten polymer from either a large spinneret having several thousand holes or with banks of smaller spinnerets containing as few as 40 holes. After exiting the spinneret, the molten fibers are quenched by a cross-flow air quench system, then pulled away from the spinneret and attenuated (drawn) by high pressure air. There are two methods of air attenuation, both of which use the venturi effect. The first draws the filament using an aspirator slot (slot draw), which runs the width of the machine. The second method draws the filaments through a nozzle or aspirator gun. Filaments formed in this manner are collected on a screen (“wire”) or porous forming belt to form the fabric. The fabric is then passed through compression rolls and then between heated calender rolls where the raised lands on one roll bond the fabric at points covering 20% to 40% of its area.

Annealing.

In additional embodiments, the mechanical properties of fibers comprising the compositions and/or blends of this invention can be improved by annealing the fibers or the nonwoven materials made from the blends of this invention. Annealing is often combined with mechanical orientation, although annealing is preferred. Annealing partially relieves the internal stress in the stretched fiber and restores the elastic recovery properties of the blend in the fiber Annealing has been shown to lead to significant changes in the internal organization of the crystalline structure and the relative ordering of the amorphous and semicrystalline phases. Annealing typically leads to improved elastic properties. The fiber or fabric is preferably annealed at a temperature of at least 40° F., preferably at least 20° F. above room temperature (but slightly below the crystalline melting point of the blend). Thermal annealing of the blend is conducted by maintaining the polymer blends or the articles made from a such a blend at temperature between room temperature to a maximum of 160° C. or more preferably to a maximum of 130° C. for a period between 5 minutes to less than 7 days. A typical annealing period is 3 days at 50° C. or 5 minutes at 100° C. While the annealing is done in the absence of mechanical orientation, the latter can be a part of the annealing process on the fiber (past the extrusion operation). Mechanical orientation can be done by the temporary, forced extension of the fiber for a short period of time before it is allowed to relax in the absence of the extensional forces. Oriented fibers are conducted by maintaining the fibers or the articles made at an extension of 100% to 700% for a period of 0.1 seconds to 24 hours. A typical orientation is an extension of 200% for a momentary period at room temperature.

For orientation, a fiber at an elevated temperature (but below the crystalline melting point of the polymer) is passed from a feed roll of fiber around two rollers driven at different surface speeds and finally to a take-up roller. The driven roller closest to the take-up roll is driven faster than the driven roller closest to the feed roll, such that the fiber is stretched between the driven rollers. The assembly may include a roller intermediate the second roller and take-up roller to cool the fiber. The second roller and the take-up roller may be driven at the same peripheral speeds to maintain the fiber in the stretched condition. If supplementary cooling is not used, the fiber will cool to ambient temperature on the take up roll.

For more information on fiber and nonwoven production please see Polypropylene Handbook, E. P. Moore, Jr., et al., Hanser/Gardner Publications, Inc. New York, 1996, pages 314 to 322, which is incorporated by reference herein.

Nonwoven Web.

In one embodiment, a nonwoven fiber web is prepared from the compositions of this invention or a blend thereof. The fibers employed in such a web typically and preferably have denier ranging from about 0.5 to about 10 (about 0.06 to about 11 tex), although higher denier fibers may also be employed. Fibers having denier from about 0.5 to 3 (0.06 to about 3.33 tex) are particularly preferred (“Denier” means weight in grams of 9000 meters of fiber, whereas “tex” means weight in grams per kilometer of fiber). Fiber stock having a length ranging from about 0.5 to about 10 cm is preferably employed as a starting material, particularly fiber lengths ranging from about 3 to about 8 cm. Nonwoven webs of fibers may be made using methods well documented in the nonwoven literature (see, for example, Turbak, A. “Nonwovens: An Advanced Tutorial”, Tappi Press, Atlanta, Ga., (1989). The uncoated (i.e., before application of any binder) web should have a thickness in the range of about 10 to 100 mils (0.254 to 2.54 mm), preferably 30 to 70 mils (0.762 to 1.778 mm), more preferably 40 to 60 mils (1.02 to 1.524 mm). These preferred thicknesses may be achieved either by the carding/crosslapping operation or via fiber entanglement (e.g., hydroentanglement, needling, and the like). The basis weight of the uncoated web preferably ranges from about 20 g/m² up to about 250 g/m². In some embodiments, one may improve the tensile and tear strength of the inventive articles, and reduce lint on the surface of the articles, by entangling (such as by needletacking, hydroentanglement, and the like) the nonwoven web, or calendering the uncoated and/or coated and cured nonwoven web. Hydroentanglement may be employed in cases where fibers are water insoluble. Calendering of the nonwoven web at temperatures from about 5 to about 40° C. below the melting point of the fiber may reduce the likelihood of lint attaching to the surface of the ultimate articles and provide a smooth surface. Embossing of a textured pattern onto the nonwoven web may be performed simultaneously with calendering, or in a subsequent step.

In addition to the compositions of the invention or any blends thereof, it may also be desirable to add colorants (especially pigments), softeners (such as ethers and alcohols), fragrances, fillers (such as for example silica, alumina, and titanium dioxide particles), and bactericidal agents (for example iodine, quaternary ammonium salts, and the like) to the blends.

Likewise, the nonwoven webs and fibers may be coated with other materials, such as binders, adhesives, reflectants, and the like. Coating of the nonwoven web or the fiber may be accomplished by methods known in the art, including roll coating, spray coating, immersion coating, ink jet applications, gravure coating, or transfer coating. The coating weight as a percentage of the total wiping article may be from about 1% to about 95%, preferably from about 10% to about 60%, more preferably 20 to 40%.

Staple fibers may also be present in the nonwoven web. The presence of staple fibers generally provides a more lofty, less dense web than a web of only blown microfibers. Preferably, no more than about 90 weight percent staple fibers are present, more preferably no more than about 70 weight percent. Such webs containing staple fiber are disclosed in U.S. Pat. No. 4,118,531 (Hauser) which is incorporated herein by reference.

Sorbent particulate material such as activated carbon or alumina may also be included in the web. Such particles may be present in amounts up to about 80 volume percent of the contents of the web. Such particle-loaded webs are described, for example, in U.S. Pat. No. 3,971,373 (Braun), U.S. Pat. No. 4,100,324 (Anderson) and U.S. Pat. No. 4,429,001 (Kolpin et al.), which are incorporated herein by reference.

The fibers and nonwoven webs prepared using the blends of this invention can be formed into fabrics, garments, clothing, medical garments, surgical gowns, surgical drapes, diapers, training pants, sanitary napkins, panty liners, incontinent wear, bed pads, bags, packaging material, packages, swimwear, body fluid impermeable backsheets, body fluid impermeable layers, body fluid permeable layers, body fluid permeable covers, absorbents, tissues, nonwoven composites, liners, cloth linings, scrubbing pads, face masks, respirators, air filters, vacuum bags, oil and chemical spill sorbents, thermal insulation, first aid dressings, medical wraps, fiberfill, outerwear, bed quilt stuffing, furniture padding, filter media, scrubbing pads, wipe materials, hosiery, automotive seats, upholstered furniture, carpets, carpet backing, filter media, disposable wipes, diaper coverstock, gardening fabric, geomembranes, geotextiles, sacks, housewrap, vapor barriers, breathable clothing, envelops, tamper evident fabrics, protective packaging, and coasters.

The fibers prepared using the blends of this invention can be formed into yarns, woven fabrics, nonwoven fabrics, hook and loop fasteners, fabrics, garments, clothing, medical garments, surgical gowns, surgical drapes, diapers, training pants, sanitary napkins, panty liners, incontinent wear, bed pads, bags, packaging material, packages, swimwear, body fluid impermeable backsheets, body fluid impermeable layers, body fluid permeable layers, body fluid permeable covers, absorbents, tissues, nonwoven composites, liners, cloth linings, scrubbing pads, face masks, respirators, air filters, vacuum bags, oil and chemical spill sorbents, thermal insulation, first aid dressings, medical wraps, fiberfill, outerwear, bed quilt stuffing, furniture padding, filter media, scrubbing pads, wipe materials, hosiery, automotive seats, upholstered furniture, carpets, carpet backing, filter media, disposable wipes, diaper coverstock, gardening fabric, geomembranes, geotextiles, sacks, housewrap, vapor barriers, breathable clothing, envelops, tamper evident fabrics, protective packaging, and coasters.

Fabrics that utilize the fibers of this invention can be made by knitting or weaving or by non-woven processes such as melt blown or spun bond. In some embodiments, the fabric of this invention is made using one or more different (conventional) fibers in combination with the fibers of the invention. Hard fibers, such as nylon and/or polyester may be used, but others such as rayon, silk, wool, modified acrylic and others can also be utilized to make the fabric of this invention.

Undergarments, such as bras and T-shirts as well as sport garments used for activities such as running, skiing, cycling, or other sports, can benefit from the properties of these fibers. It will be understood by those skilled in the art that any garment can be made from the fabric and fibers of this invention. An exemplary embodiment would be a bra shoulder strap made from woven fabric and the wings of the bra made from knitted fabric, with both the woven and the knitted fabric containing the melt spun TPU fibers of this invention.

In other embodiments, the fibers described herein are used to make one or more of any number of garments and articles including but not limited to: sports apparel, such as shorts, including biking, hiking, running, compression, training, golf, baseball, basketball, cheerleading, dance, soccer and/or hockey shorts; shirts, including any of the specific types listed for shorts above; tights including training tights and compression tights; swimwear including competitive and resort swimwear; bodysuits including wrestling, running and swimming body suits; and footwear. Additional embodiments include workwear such as shirts and uniforms. Additional embodiments include intimates including bras, panties, men's underwear, camisoles, body shapers, nightgowns, panty hose, men's undershirts, tights, socks and corsetry. Additional embodiments include medical garments and articles including: hosiery such as compression hosiery, diabetic socks, static socks, and dynamic socks; therapeutic burn treatment bandages and films; wound care dressings; medical garments. Additional applications include military applications that mirror one or more of the specific articles described above. Additional embodiments include bedding articles including sheets, blankets, comforters, mattress pads, mattress tops, and pillow cases.

### Additional Applications

The invention also provides a footwear article comprising at least one component formed from an inventive composition. In a further embodiment, the article is selected from the group consisting of shoe outsole, shoe midsole, shoe unitsole, an overmolded article, a natural leather article, a synthetic leather article, an upper, a laminated article, a coated article, a boot, a sandal, galoshes, a plastic shoe, and combinations thereof.

The invention also provides a thermoformed sheet comprising at least one layer formed from an inventive composition.

The invention also provides an automotive part comprising at least one layer formed from an inventive composition. The invention also provides an automotive part such as an instrument panel or a door panel formed from an inventive composition.

The invention also provides artificial leather comprising at least one component formed from an inventive composition.

The invention also provides artificial turf comprising at least one component formed from an inventive composition.

The invention also provides an adhesive comprising at least one component formed from an inventive composition. The invention also provides a coated substrate comprising an inventive adhesive, and at least one component formed from Kevlar.

The invention also provides an article formed from an inventive composition, and wherein the article has a surface energy greater than, or equal to, 35 dynes/cm.

An inventive article may comprise a combination of two or more embodiments as described herein.

The TPU and/or TPU compositions described above may be employed in a wide variety of applications including, but not limited to, tie layers between extruded sheets or films or profiles, fiber, aqueous dispersions, automotive products (e.g., skins, airbags, head rests, arm rests, headliners, carpet underlayment, etc.), awnings, tarps, roofing construction (e.g., adhesives to epoxy, urethane or acrylic-based substrates for all roofing applications such as insulation bonding, liquid roofing, facade sealant, expansion joints, wet-room sealants, pitched roof, acrylics-adhered roof, bitumen bonding and PUR-adhered refurbishment), paintable automobile skins and steering wheels, paintable injection molded toys, powder coatings, powder slush moldings or rotational cast moldings (typically, each with a particle size of less than 950 micron), consumer durables, grips, handles, computer components (e.g., key pads), belts, adhesive for fabric/polyurethane (PU) foam laminates (e.g., appliques and footwear), adhesives (hot melt or otherwise), e.g., for binding an abrasion layer to an extruded article, conveyor and timing belts, fabric, carpet, artificial turf, coatings, wire and cable, and raincoats and similar protective apparel. In some embodiments, the articles of the invention include a hot melt adhesive system utilizing the TPU compositions described herein.

The inventive compositions may be used as primers, paints and coatings. Primer applications include, but are not limited to, primers for wall paper, wall bases, footwear components, automotive skins, automotive tubings and other automotive components. The inventive compositions may be used as primers to promote the adhesion of polyolefin substrates to polar glues and coatings, such as conventional polyurethane glues and coatings. The inventive compositions may be used as primers for polyethylene terephthalate (PET) braids, and cords used in automotive belts, to promote polyolefin adhesion to these substrates. The inventive compositions may also be used as adhesives or cast films for footwear or automotive applications, and as barrier layers or barrier films between olefinic and polar substrates, such as a barrier layer between a soft TPU skin and polyurethane foam, glue or coating.

The invention also provides a painted substrate, wherein the substrate is formed from an inventive composition. In one embodiment, the paint comprises at least one additive selected from the group consisting of an acrylic polymer, an alkyl resin, a cellulose-based material, a melamine resin, a urethane resin, a carbamate resin, a polyester resin, a vinyl acetate resin, an epoxy, a polyol and/or an alcohol. In another embodiment, the paint is a water-based paint. In another embodiment, the paint is an organic solvent based paint.

The invention also provides a dispersion comprising an inventive composition. In another embodiment, the dispersion further comprises at least one additive of selected from the group consisting of an acrylic polymer, an alkyd resin, a cellulose-based material, a melamine resin, a urethane resin, a carbamate resin, a polyester resin, a vinyl acetate resin, an epoxy a polyol, an alcohol, and combinations thereof. In another embodiment, the dispersion is a water-based dispersion. In another embodiment, the dispersion is an organic solvent-based dispersion.

The invention also provides for tapes including seam tapes and adhesive tapes, where the adhesive component of the tape includes the TPU compositions of the invention.

The invention will be better understood by reference to the following examples.

### EXAMPLES

The invention will be further illustrated by the following examples, which sets forth particularly advantageous embodiments. While the examples are provided to illustrate the invention, they are not intended to limit it.

### Example Set A

A set of examples is prepared to demonstrate the ultra-soft non-tacky TPU compositions of the invention. The examples of this set are plasticizer free TPU compositions.

Examples A-1 and A-2 polyether TPU compositions each prepared on a lab scale batch process by combining all of their respective components in a reaction vessel which is then heated to 120° C. and reacted for about 3 minutes. The resulting material is then aged for 3 hours at 105° C. Each sample is then tested to evaluate its physical properties. Example A-1 is also analyzed by 2D-TOCSY NMR (total correlation spectroscopy) to confirm the connection between the crystalline chain end and TPU main chain. That is the crystalline chain ends are covalently bonded to the polymer network in the TPU of Example A-2.

The formulations and test results for the examples are summarized in the table below, where are formulation values are weight percentages.

TABLE 1
Lab Scale Examples

| | Example | Example |
|---|---|---|
| | A-1 | A-2 |
| | Comp | Inventive |
| MDI | 20.9 | 20.4 |
| 1000 Mn PTMEG | 78.5 | 76.6 |
| UNILIN ™ 700 (C63) (crystalline) | 0.0 | 3.0 |
| Butyl Carbitol¹ (non-crystalline) | 0.6 | 0.0 |
| Chain terminator to OH equivalents | 2.11 | 2.11 |
| Mw (kDa) via GPC² | 260 | 328 |
| Mn (kDa) via GPC² | 94 | 112 |
| Tensile Strength (MPa)³ | 0.19 | 23 |
| Elongation (%)³ | 2076 | 714 |
| Share A Hardness⁴ | 34 | 64 |
| Glass Transition Temp, Tg (° C.)⁵ | −48.5 | −48.1 |
| Melting Temp, Tm (° C.)⁵ | None | 89.1 |
| Crystallization Temp, Tc (° C.)⁵ | None | 71.6 |

¹Butyl carbitol, (2-(2-butoxyethoxy)ethanol), is a non-crystalline chain terminator available from DOW.
²GPC molecular weights are determined against polystyrene standards and are conducted in THF.
³Tensile strength and elongation are measured using ASTM D412 using compression molded plaques.
⁴Hardness values are measured using ASTM D2240.
⁵Tg, Tm, and Tc are measured using modulated DSC (ASTM D3418 method). Tg and Tm are obtained from second heating and Tc is obtained from the cooling curves.

In both formulations, no-chain extender was used and the chain terminators are used in the same hydroxyl equivalent values (2.11). Example A-2 is a high strength non-tacky polymer with a low melting temperature and crystallization temperature, all indicating a useful TPU with good processing characteristics. Whereas Example A-1 is extremely sticky with no sufficient mechanical strength and which did not have a measurable melting temperature or crystallization temperature, properties indicating the A-1 Example would be very hard to prepare and to further process on a commercial scale. These lab scale examples show the TPU compositions of the invention (Example A-2) provide a TPU with a desirable combination of properties while avoiding the issues seen in comparable TPU compositions not made according to the invention (Example A-1).

Examples A-3, A-4 and A-5 are polyester TPU compositions each prepared in a research scale continuous extruder where each component is feed into the extrude as a separate stream, except that the additional additives are pre-mixed with the polyol component and charged to the extruder with the polyol. The formulations and test results for the examples are summarized in the table below, where all formulation values are weight percentages.

TABLE 2
Continuous Extruder Examples

| | Example | Example | Example |
|---|---|---|---|
| | A-3 | A-4 | A-5 |
| | Inventive | Inventive | Comp |
| MDI | 20.1 | 20.2 | 19.9 |
| 1000 Mn BDO-adipate | 78.1 | 76.1 | 79.4 |
| UNILIN ™ 350 (C63) (crystalline) | 1.0 | 3.0 | |
| Additional Additives¹ | 0.7 | 0.7 | 0.7 |
| Mw (kDa) via GPC² | 159 | 117 | Not Tested |
| Mn (kDa) via GPC² | 63 | 43 | Not Tested |
| Tensile Strength (MPa)³ | 9.0 | 11.0 | Not Tested |
| Elongation (%)³ | 845 | 1010 | Not Tested |
| Share A Hardness⁴ | 51 | 54 | Not Tested |
| Glass Transition Temp, Tg (° C.)⁵ | −30.1 | −29.6 | Not Tested |
| Melting Temp, Tm (° C.)⁵ | 66.5 | 61.9 | Not Tested |
| Crystallization Temp, Tc (° C.)⁵ | 70 | 71 | Not Tested |

¹The same package of additional additives was used in each example.
²GPC molecular weights are determined against polystyrene standards and are conducted in THF.
³Tensile strength and elongation are measured using ASTM D412 using compression molded plaques.
⁴Hardness values are measured using ASTM D2240.
⁵Tg, Tm, and Tc are measured using modulated DSC (ASTM D3418 method). Tg and Tm are obtained from second heating and Tc is obtained from the cooling curves.

Example A-3 and A-4 are non-tacky, moldable, and soft TPU materials with no processing issues. Both processed well in the research scale extruder and samples of the completed TPU materials could be collected and tested. Both examples showed good physical properties with low melting temperatures and crystallization temperatures, all indicating a useful TPU with good processing characteristics. In contrast, Example A-5 was not processable due to lack of any mechanical strength and extreme sticking of the TPU material inside the equipment. Because of these difficulties, no samples could be collected for testing and the TPU proved to be essentially non-processable.

### Example Set B

A set of examples is prepared to demonstrate the improved processability of the TPU compositions of the invention. The examples of this set are plasticizer free TPU compositions.

Examples B-1, B-2, B-3, and B-4 are polycarbonate TPU compositions each prepared in a research scale continuous extruder where each component is feed into the extrude as a separate stream, except that the additional additives are pre-mixed with the polyol component and charged to the extruder with the polyol. The formulations and test results for the examples are summarized in the table below, where the formulation values are weight percentages.

TABLE 3

| | Example | Example | Example | Example |
|---|---|---|---|---|
| | B-1 | B-2 | B-3 | B-4 |
| | Comp | Inventive | Inventive | Inventive |
| MDI | 28.4 | 28.8 | 28.8 | 29.1 |
| Polycarbonate diol | 61.2 | 58.3 | 56.3 | 54.4 |
| BDO | 7.5 | 7.5 | 7.5 | 7.5 |
| UNILIN ™ 700 (C63) | 0.0 | 3.0 | 5.0 | 7.0 |
| (crystalline) | | | | |
| Additional Additives¹ | 2.9 | 2.5 | 2.4 | 2.0 |
| Glass Transition Temp, | 1.8 | 2.4 | 2.5 | 0.7 |
| Tg (° C.)² | | | | |
| Melting Temp, | 137 | 119/155 | 118/158 | 118/160 |
| Tm (° C.)² | | | | |
| Crystallization Temp, | None | 71/101 | 71/103 | 70/105 |
| Tc (° C.)² | | | | |
| Can be easily processed | No | Yes | Yes | Yes |
| into a sheet? | | | | |

¹The same package of additional additives was used in each example.
²Tg, Tm, and Tc are measured using modulated DSC (ASTM D3418 method). Tg and Tm are obtained from second heating and Tc is obtained from the cooling curves.

Example B-1 is completely amorphous (no crystallization point) polycarbonate TPU with a high degree of phase mixing and longer solidification times resulting in significant processing issues such as tackiness when this material is extruded into sheet or tubing. Thus Example B-1 would be very difficult to process into finished articles (via extruding, molding, etc). Examples B-2, B-3, and B-4 are polycarbonate TPUs prepared according to the invention and are shown to have sharp Tc transitions. No tackiness issues are observed when Example B-2, B-3, and B-4 formulations are extruded into sheet. Thus, the inventive examples demonstrated good processing characteristics (including processing in continuous reactive extruders) as well as good properties for further processing into finished articles (via extruding, molding, etc).

### Example Set C

A set of examples is prepared to demonstrate the crosslinking properties of the TPU compositions of the invention. The examples of this set are plasticizer free TPU compositions.

Examples C-1 and C-2 polyether TPU compositions each prepared on a lab scale batch process by combining all of their respective components in a reaction vessel which is then heated to 120° C. and reacted for about 3 minutes. The resulting material is then aged for 3 hours at 105° C. Each sample is then exposed to UV radiation and tested to determine the level of crosslinking that has occurred. This testing involves preparing a compression molded plaque with a 3-5 mil thickness from the TPU composition of each example. These plaques are then cured with UV light using an H UV lamp covering both UVC and UVB wavelengths with intensity of −0.56 W/cm² and average irradiation density of 0.9 J/cm². The cured samples are then placed in hot THF for 30 minutes. Non-crosslinked samples will completely dissolve in less than 5 min. A sample that does not dissolve in the THF indicates formation of at least a partially crosslinked network.

The formulations and test results for the examples are summarized in the table below, where the formulation values are weight percentages.

TABLE 4

| | Example | Example |
|---|---|---|
| | C-1 | C-2 |
| | Inventive | Inventive |
| MDI | 25.1 | 24.9 |
| 1000 Mn PTMEG | 63.4 | 63.4 |
| UNILIN ™ 350 (C63) (crystalline) | 7.0 | 0.0 |
| UNILIN ™ 700 (C63) (crystalline) | 0.0 | 7.0 |
| BDO | 2.6 | 2.8 |
| IRGACURE ™ 651¹ | 2.0 | 2.0 |
| Did the sample dissolve in THF? | No | No |

¹IRGARCURE ™ 651 is a photoinitiator available from Ciba.

### Example Set D

A set of examples is prepared to demonstrate the improved compatibility the TPU compositions of the invention provide when blended with other polymers.

Examples D-1 and D-2 polyether TPU compositions are each prepared in a research scale continuous extruder where each component is fed into the extruder as a separate stream, except that the additional additives are pre-mixed with the polyol component and charged to the extruder with the polyol. The formulations and test results for the examples are summarized in the table below, where all formulation values are weight percentages.

TABLE 5

| | Example | Example |
|---|---|---|
| | D-1 | D-2 |
| MDI | 27.8 | 28.3 |
| 1000 Mn PTMEG | 65.3 | 65.3 |
| UNILIN ™ 700 (C63) (crystalline) | 3.0 | 3.0 |
| BDO | 4.0 | 4.0 |
| Stoichiometry (%) | 100.1 | 102.0 |
| Melt Flow Index (g/10 min)¹ | 381 | 120 |

¹Melt flow index is measured at 190° C. using 8700 gram load.

The stoichiometry is controlled by changing the MDI flow rate. The stoichiometry is changed to modify the final polymer MW.

Examples D-3, D-4, and D-5 are blends prepared from Examples D-1 and D-2. The blends are prepared using small a lab scale Brabender extruder with 3 mixing zones and a die. The following temperature profile was used in the Brabender: 190° C.-200° C.-210° C.-250° (Die).

The formulations for the examples are summarized in the table below, where the formulation values are weight percentages.

TABLE 6

| | Example | Example | Example |
|---|---|---|---|
| | D-3 | D-4 | D-5 |
| | Comp | Inventive | Inventive |
| LDPE¹ | 50 | 40 | 40 |
| Polyether TPU² | 50 | 50 | 50 |
| D-1 | 0 | 10 | 0 |
| D-2 | 0 | 0 | 10 |
| Tensile Strength (MPa)³ | 7 | 12 | 8 |
| Elongation (%)³ | 31 | 484 | 203 |

¹LDPE is a commercially available low density polyethylene polymer.
²The polyether TPU is a commercially available MDI-PTMEG-BDO TPU.
³Tensile strength and elongation are measured using ASTM D412 using compression molded plaques.

No stress transfer was observed for Example D-3 which gave very poor tensile strength and percent elongation values, suggesting no compatibility between the LDPE and TPU phases. When the TPU compositions of the invention are added in the small amount, acting as a blend compatiblizer, significant improvements in stress transfer is observed between the LDPE and TPU phases of the blends.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Except where otherwise indicated, all numerical quantities in the description specifying amounts or ratios of materials are on a weight basis. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration. All of the embodiments of the invention described herein are contemplated from and may be read from both an open-ended and inclusive view (i.e. using “comprising of” language) and a closed and exclusive view (i.e. using “consisting of” language).

1. An article comprising a thermoplastic polyurethane composition, where the thermoplastic polyurethane composition comprises the reaction product of (i) a polyisocyanate component, (ii) at least one of a chain extender component and a polyol component, and (iii) a chain terminator component;
wherein the chain terminator component comprises a short chain crystalline compound containing more than 12 carbon atoms and a single NCO-reactive functional group capable of terminating the chain of a thermoplastic polyurethane resulting from the reaction of components (i) and (ii).

2. The article of claim 1 wherein the functional group of the short chain crystalline compound is an active-hydrogen functional group located at a terminal position within the crystalline compound.

3. The article of claim 1 wherein the functional group of the short chain crystalline compound is a hydroxyl (alcohol) functional group, a primary amine functional group, a secondary amine functional group, an anhydride functional group, an epoxy functional group, a thiol functional group, a carboxy (carboxylic acid) functional group, an isocyanate functional group, or a combination thereof.

4. The article of claim 1 wherein the short chain crystalline compound is a polyolefin that contains from 20 to 70 carbon atoms.

5. The article of claim 1 wherein the short chain crystalline compound comprises one or more alpha-hydroxy terminated polyalphaolefins or ethoxylated versions thereof;
wherein the polyalphaolefin comprises a polyethylene, a polypropylene, a poly(ethylene-co-alphaolefin) copolymer, a poly(propylene-co-alphaolefin) copolymer, or any combination thereof.

6. The article of claim 1 wherein the thermoplastic polyurethane is represented by the following structure: 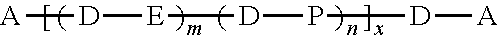
wherein each A is an end group derived from the mono-functional short chain crystalline compound; each D is a group derived from the polyisocyanate component; each E is derived from the chain extender component; each P is derived from the polyol component; each m is an integer from 0 to 15; each n is an integer from 0 to 20; and x is an integer from 1 to 50; with the proviso that at least one of m and n is greater than 0.

7. The article of claim 1 wherein the polyisocyanate component comprises a diisocyanate;
wherein the chain extender component, when present, comprises a diol, a diamine, or a combination thereof; and
wherein the polyol component, when present, comprises a polyether polyol, a polyester polyol, a polycarbonate polyol, a polysiloxane polyol, or a combination thereof.

8. The article of claim 1 wherein the thermoplastic polyurethane composition comprises one or more additional polymeric components, additives, or combinations thereof.

9. The article of claim 1 wherein the article is prepared by calendering, casting, coating, compounding, extrusion, foaming, laminating, blow molding, compression molding, injection molding, thermoforming, transfer molding, cast molding, rotational molding, casting such as for films, spun or melt bonded such as for fibers, or any combination thereof.

10. The article of claim 1 wherein the thermoplastic polyurethane composition is included in a film.

11. The article of claim 10 wherein the film comprises a monolayer film, a multilayer film, a breathable film, or any combination thereof.

12. The article of claim 10 wherein the film is formed by extrusion, co-extrusion, extrusion coating, lamination, blowing and then casting, or any combination thereof.

13. The article of claim 1 wherein the thermoplastic polyurethane composition is included in a molded product.

14. The article of claim 13 wherein the molded product comprises a molded part, an over-molded part, a molded laminate thermoplastic polyurethane composition, a molded foamed thermoplastic polyurethane composition, or any combination thereof.

15. The article of claim 13 wherein the molded product is formed by injection molding, gas-assisted injection molding, blow molding, extrusion blow molding, injection blow molding, injection stretch blow molding, compression molding, rotational molding, foam molding, thermoforming, sheet extrusion, profile extrusion, vacuum forming, slush molding, transfer molding, wet lay-up or contact molding, cast molding, cold forming matched-die molding, spray techniques, profile co-extrusion, or any combination thereof.

16. The article of claim 1 wherein the thermoplastic polyurethane composition is included in a fiber.

17. The article of claim 16 wherein the fiber comprises a monofilament fiber or multifilament fiber.

18. The article of claim 16 wherein the fiber is formed by melt blowing, spunbonding, film aperturing, staple fiber carding, continuous filament spinning, or bulked continuous filament spinning.

19. The article of claim 16 wherein the fiber is included in a fabric.

20. The article of claim 19 wherein the fabric further comprises one or more additional fibers made from materials other than the thermoplastic polyurethane composition.

21. The article of claim 19 wherein the fabric comprises a non-woven fabric, a knitted fabric, or a woven fabric.

22. The article of claim 19 wherein the fabric is included in a garment.

23. The garment of claim 22 wherein the garment comprises sports apparel, shirts, tights, bodysuits, workwear, intimates, medical garments, bedding articles, or any combination thereof.

24. The article of claim 1 wherein the thermoplastic polyurethane composition is included in a footwear article.

26. The article of claim 25 wherein the footwear article comprises a shoe outsole, a shoe midsole, a shoe unitsole, an overmolded article, a natural leather article, a synthetic leather article, an upper, a laminated article, a coated article, a boot, a sandal, galoshes, a plastic shoe, or any combinations thereof.

27. The article of claim 1 wherein the thermoplastic polyurethane composition is included in an extruded article.

28. The article of claim 27 wherein the extruded article comprises a sheet, a film, a tube, a hose, a jacket of a wire and cable construction, a combination of one or more thereof, or a liner of one or more thereof.

29. A process of making an article comprising a thermoplastic polyurethane composition, where said process comprises the steps of:
(I) reacting (i) a polyisocyanate component, (ii) at least one of a chain extender component and a polyol component, and (iii) a chain terminator component;
wherein the chain terminator component comprises a short chain crystalline compound containing a single functional group capable of terminating the chain of a thermoplastic polyurethane resulting from the reaction of components (i) and (ii);
resulting in a thermoplastic polyurethane with crystalline end groups; and
(II) forming said article from the thermoplastic polyurethane with crystalline end groups.
